(19) United States
(12) Patent Application Publication
(10) Pub. No.: US 2016/0209082 A1
(43) Pub. Date: Jul. 21, 2016

(54) COLD HEAT ENGINE

(71) Applicant: Ong Kian YANG, Raub (MY)

(72) Inventor: Ong Kian YANG, Raub (MY)

(21) Appl. No.: 14/810,330

(22) Filed: Jul. 27, 2015

(30) Foreign Application Priority Data
Aug. 4, 2014 (MY) PI 2014002273

(51) Int. Cl. F24J 3/08; F24J 3/06

(52) U.S. Cl. CPC F24J 3/08; F24J 3/06

(57) ABSTRACT

The present invention provides a cold heat engine designed to work at a lower temperature compared to the environment temperature which allows for zero fuel consumption and emission. Substances such as acetone or methanol can be used to obtain a required result. The cold heat engine earns mechanical energy by the expansion of the second substance in high temperature and compression in low temperature. The cold heat engine also comprises a container and a heat exchanger, where the heat exchanger is designed to exchange heat energy.

### FIELD OF INVENTION

The present invention relates to a cold heat engine. More particularly, the present invention relates to a cold heat engine designed to provide high efficiency mechanical energy output and to eliminate consumption of fuel with convert the entire heat energy of the engine absorbed to mechanical energy.

### BACKGROUND OF INVENTION

In thermodynamics, a heat engine is a system that performs the conversion of heat or thermal energy to mechanical energy which can then be used to do mechanical work. The heat engine performs this process by bringing a working substance from a higher state temperature to a lower state temperature. A heat “source” generates thermal energy that brings the working substance to the high temperature state. The working substance generates work in the “working body” of the engine while transferring heat to the colder “sink” until it reaches a low temperature state. During this process some of the thermal energy is converted to work by exploiting the properties of the working substance. The working substance can be any system with a non-zero heat capacity, but it is usually a gas or liquid.

Gasoline and diesel engines, jet engines, and steam turbines are all heat engines that do work by using part of the heat transfer from heat source. These heat engines provide some reasonable amount of efficiency, however they also result in the emission of many harmful gases in the atmosphere and also certain fuels such as coal, gasoline and diesel are generally depleting irreplaceable sources of energy. Further, existing heat engines also cannot convert all the heat energy provided by heat sources to mechanical energy.

Cold heat engine is a type of engine which has a certain mechanism similar with heat engines, but offers a different method or cycle to absorb the heat energy from the surrounding environment and converts this source of heat energy to mechanical energy. One of the key features of the cold heat engine is that when the engine starts running the engine temperature goes down, it can only work at certain temperatures lower than the environment temperature. Cold heat engines can be considered as an ideal replacement for existing heat engines, since they are a source of zero emission and zero fuel consumption, they only need to absorb heat energy from the environment. Even substantially cold temperatures can provide heat energy to the cold heat engine which can work at that reduced temperature to generate a reasonable amount of mechanical energy.

Cold heat engines comprise of a working substance which expands at high temperature and compresses at low temperature. Cold heat engines need a source of heat as well as cold and are responsible in allowing the working substance to convert from heat energy to mechanical energy. The temperature of running cold heat engine is colder than all the substances of the surrounding environment which come into contact with it and the cold heat engines also absorbs heat energy from them such as the atmosphere, air, water, earth and so on, include the heat energy converted from heat radiation like all the electromagnetic waves. Therefore, this engine does not lose any heat energy to the environment but absorbs heat energy from the surrounding substances.

The advantages of cold heat engines compared to existing heat engines are that it offers zero fuel consumption, zero emission, more safety features as no fuel or high engine temperature is required. Besides, the cold heat engine is relatively small in size and light in engine weight as compared to petrol engines.

### SUMMARY OF THE INVENTION

Accordingly, the present invention provides a cold heat engine designed to provide high efficiency mechanical energy output and to eliminate consumption of fuel by converting heat energy absorbed from environment to mechanical energy, said cold heat engine comprising a first substance to produce compression heat, heat absorption of expansion and let latent heat occurs when substance change phase, wherein said first substance releases and absorbs heat energy, a second substance to produce compression heat, heat absorption of expansion and let latent heat occurs when the second substance changes phase, wherein the second substance releases and absorbs heat energy, said second substance expands in a high temperature and compresses in a low temperature to earn a substantial amount of mechanical energy, wherein said second substance absorbs heat energy from said first substance and let said first substance to absorb heat energy from said second substance, a container containing said first substance and said second substance, wherein said container is built by high heat conductivity material of at least one of aluminium alloy, steel, carbon fibre or any other suitable material and a heat exchanger designed to allow said first substance and said second substance to exchange said heat energy, wherein the heat energy can also be absorbed from the environment by the surface at a side section, wherein said first substance and said second substance are substances which cooperate together to absorb heat energy from the environment and convert the heat energy to said mechanical energy.

### BRIEF DESCRIPTION OF THE DRAWINGS

In the accompanying figures, similar reference numerals may refer to identical or functionally similar elements. These reference numerals are used in the detailed description to illustrate various embodiments and to explain various aspects and advantages of the present disclosure:

FIGS. 1A, 1B, 1C, and 1D are schematic diagrams depicting the functionality of cold heat engine, according to the embodiments as disclosed herein;

FIG. 2 is a schematic diagram depicting the functionality of systems and substances in used at cold heat engine, according to the embodiments as disclosed herein;

FIGS. 2A, 2B, 2C, 2D, 2E, 2F, 2G, 2H and 2I are schematic diagrams depicting the functionality of cold heat engine which uses acetone and methanol, according to the embodiments as disclosed herein;

FIG. 2J is the diagram show the effect of pressure on the melting point;

FIG. 3 is a schematic diagram depicting how the aluminium alloy tube contains high pressure substance inside the heat exchanger, according to the embodiments as disclosed herein;

FIG. 4 is a schematic diagram of how the type 1 heat exchanger of the present invention absorbs heat energy from the environment, according to the embodiments as disclosed herein;

FIG. 5 is a schematic diagram of how the type 2 heat exchanger of the present invention absorbs heat energy from the environment according to the embodiments as disclosed herein;

FIG. 6 is a schematic diagram of how the type 3 heat exchanger of the present invention absorbs heat energy from the environment, according to the embodiments as disclosed herein;

FIG. 7 is a schematic diagram depicting how the cold heat engine keeps coldness away from the environment temperature, according to the embodiments as disclosed herein;

FIGS. 8A and 8B depict the table representations and readings for the influence of viscosity from acetone and methanol;

FIGS. 9A, 9B, 9C and 9D are schematic diagrams depicting the functionality of cold heat engine which uses water and compressed atmosphere air, according to the embodiments as disclosed herein; and

FIG. 9E is the diagram show the compression heat of water.

### DETAILED DESCRIPTION OF THE EMBODIMENTS

The above-mentioned needs are met by a method and apparatus for using a cold heat engine 100 in order to eliminate consumption of fuel result in zero emission and to convert the entire absorbed heat energy to mechanical energy. The following detailed description is intended to provide example implementations to one of ordinary skill in the art, and is not intended to limit the invention to the explicit disclosure, as one or ordinary skill in the art will understand that variations can be substituted that are within the scope of the invention as described.

The cold heat engine 100 comprises of a substance A 101, substance B 102, and a heat exchanger 103. In a cold heat engine 100 based on this method, substance A 101 provides heat energy to substance B 102 when substance B 102 is in volume expansion process at high temperatures. Further, substance A 101 absorbs heat energy from substance B 102 when substance B 102 is in the volume compression process at low temperature contrast to it expansion temperature. At the cold heat engine 100, substance B 102 is considered as the working substance, while substance A 101 is the source which provides heat energy to substance B 102 and also is considered as the source which absorbs heat energy from substance B 102.

The substance A 101 is considered as the heat source and also as the cold source to substance B 102 at different processes of the cycle in the cold heat engine 100. The heat energy from the environment absorbed by the cold heat engine 100 is considered as another heat source to substance A 101 and substance B 102 where all the heat energy absorbed by the cold heat engine 100 results in the production of mechanical energy.

In certain embodiments, when cold heat engine 100 is running based on this method, the engine 100 temperature is lower than the temperature of the substance in the surroundings which contact the cold heat engine 100. The substances A 101 and substance B 102 are not considered for combustion but there is always a reserve amount in the engine 100 and therefore results in no combustion, no exhaust and does not change to another substance. Even when flammable substances such as acetone, methanol are used it just needs to repeat the changing of the volume and the temperature which is considered more cold than the substance of environment which contacts the engine 100.

The cold engine 100 earns mechanical energy by the expansion of working substance B 102 in temperatures higher than the temperature in compression. Compared with the maximum and minimum temperature of working substance B 102 in the compression and expansion process, the temperature ranges normally from around 10° C. to 20° C. The temperature ranges normally on the substance A 101 and substance B 102 used, although it is considered as just a small temperature range, it can however greatly increase or decrease the pressure of working substance B 102 in phase changing at difference temperature. This occurs, if the ideal gas is the working substance B 102, which is capable of increasing or decreasing the pressure of ideal gases as per ideal gas law.

In a cold heat engine 100, the minimum and maximum temperature of working substance B 102 and substance A 101 is considered cold during expansion and considered as colder during compression. In cold heat engine 100 have high efficiency absorb heat energy from environment, the maximum temperature of substance A 101 and working substance B 102 (substance B) is below the temperature at surrounding environment.

Further, the substance A 101 and substance B 102 (working substance) of cold heat engine 100 can be various substances such as water, ideal gases, acetone, methanol and other substances. In an embodiment, substance A 101 and substance B 102 can cooperate to absorb heat energy from the environment and convert the heat energy to mechanical energy. Depending on various properties of substance A 101 and substance B 102, certain substance A 101 and substance B 102 need to change phase in the process and certain substances need to stay in the single phase in the process.

The substance A 101 is considered the key substance of the cold heat engine 100 based on this method, except for the heat source, it also acts as a cold source to the working substance B 102. The cold heat engine 100 has higher efficiency absorption for heat energy from the environment because the temperature of the cold heat engine 100 is always below the environment temperature. Other than the working substance B 102, substance A 101 also needs to undergo the compression and expansion process to release and absorb heat energy.

In certain aspects, in functioning of cold heat engine 100, the substance A 101 and working substance B 102 require to change phase using extremely complex calculations with parameters such as the cold heat engine 100 using acetone and methanol which is considered as substance A 101 and working substance B 102 in cold heat engine 100. A different type of the cold heat engine 100 uses liquid water and ideal gases to be the substance A 101 and substance B 102 respectively which continues to stay in a single phase in the process.

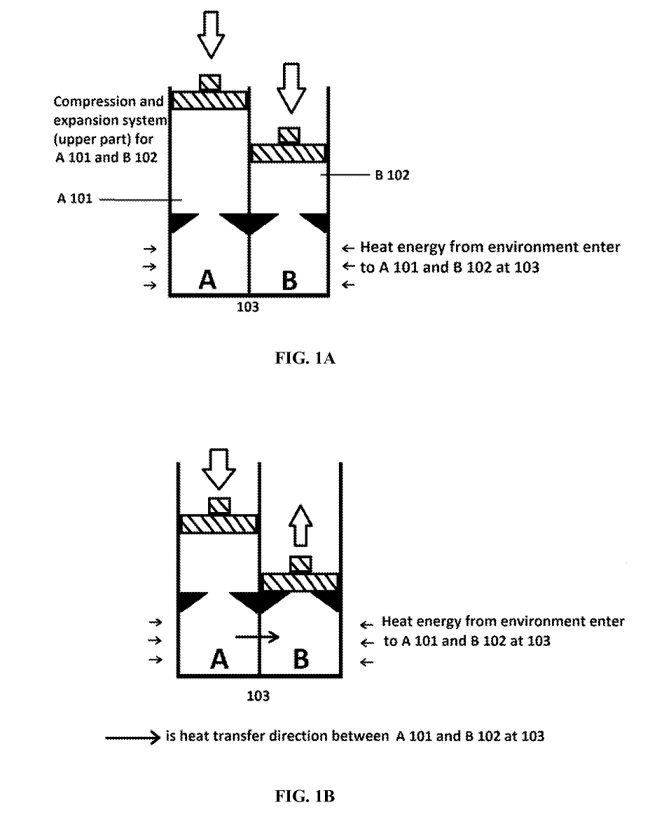

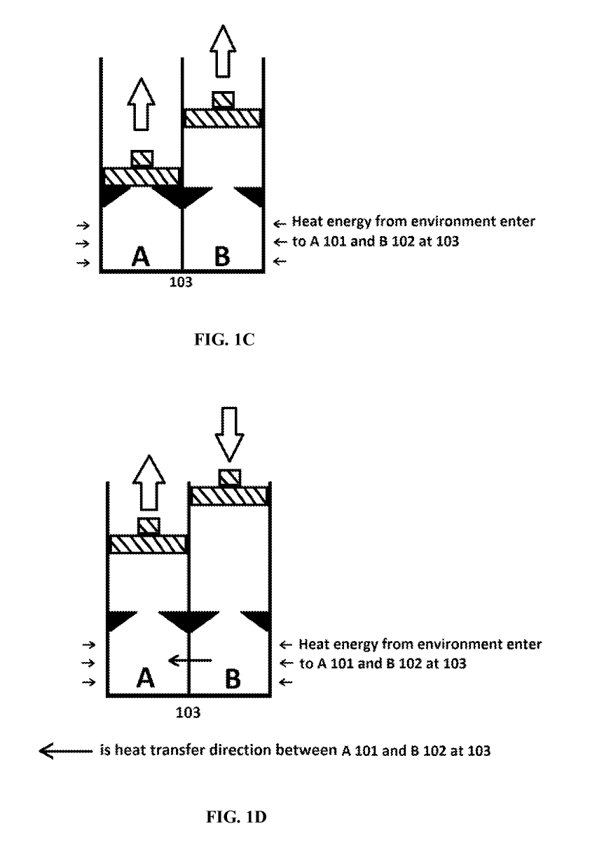

As depicted in FIG. 1A, the first step of the process is the heat up process. Initially it is required to compress substance A 101 or substance B 102 or together to increase the temperature as the substance B 102 (working substance B 102) needs to expand at high temperatures and compresses at low temperatures to earn mechanical energy. Normally, high efficiency cold heat engine 100 undergoes compression and expansion processes with both substances A 101 and substance B 102 in step 1 and step 3. However, the cold heat engine 100 may only be adapted to use the substance A 101 or substance B 102 for compression to complete heat up process in step 1 and expansion to the complete cold down process in step 3.

In FIG. 1B, step 2 is depicted. This is where the isothermal expansion process of the working substance B 102 is at a high temperature and high pressures and this step is referred to as the power step. At step 2, the isothermal expansion process is at a high temperature, but the cold heat engine 100 has a higher efficiency to absorb the heat energy from the environment, since the temperature is still lower than the substances of the environment which contact the engine 100. The expanded working substance B 102 is maintained at a high temperature to obtain more mechanical energy compared with the compression process in low temperature.

Except for the heat source from the environment surroundings, the substance A 101 in this step is the heat source to substance B 102. In the cold heat engine 100 based on this method, although substance A 101 looks like the substance which is there to support working substance B 102, the key mechanism of the cold heat engine 100 is the functioning of substance A 101. If it is to be considered that there is no function of substance A 101, it cannot be described as the cold heat engine 100 based on this method.

FIG. 1C depicts the cooling down process. The expansion of substance A 101 or substance B 102 alone or together brings the temperature to cool down substantially. This is because the working substance B 102 needs to compress at low temperatures to save or decrease the energy payment for compression. At this particular stage, the work can resume since it is close or even more than the work payload to heat up process as mentioned in step 1.

FIG. 1D depicts step 4 where the working substance B 102 is in isothermal compression process in low temperatures and low pressures. The compression of working substance B 102 is in low temperatures where the isothermal compression occurs to save or decrease the work which was paid during compression process. The work paid to compress the working substance B 102 in isothermal compression process at low temperature is lower than the work which can be obtained from the isothermal expansion process in high temperatures. The substance A 101 in step 4 is considered as the cold source to substance B 102.

Since the temperature of the cold heat engine 100 in all the four steps as described above is colder than the temperature of the substance at the surroundings which contact the cold heat engine 100, therefore the running cold heat engine 100 will absorb heat energy from the environment when the engine outputs mechanical energy. In order to earn mechanical energy, the sum total work to let the substance A 101 be the source of heat and cold must be lower than the sum work to be obtained from the working substance B 102.

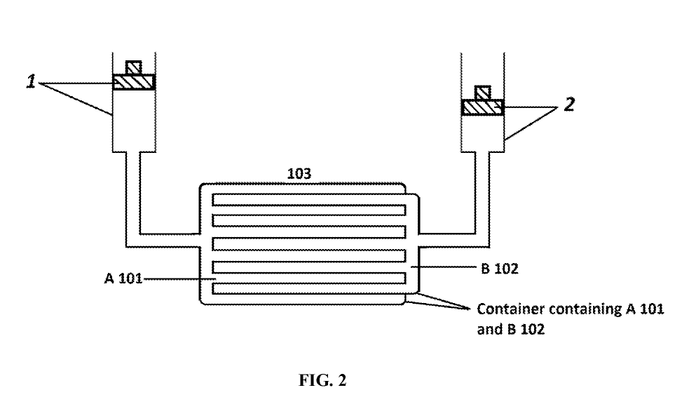

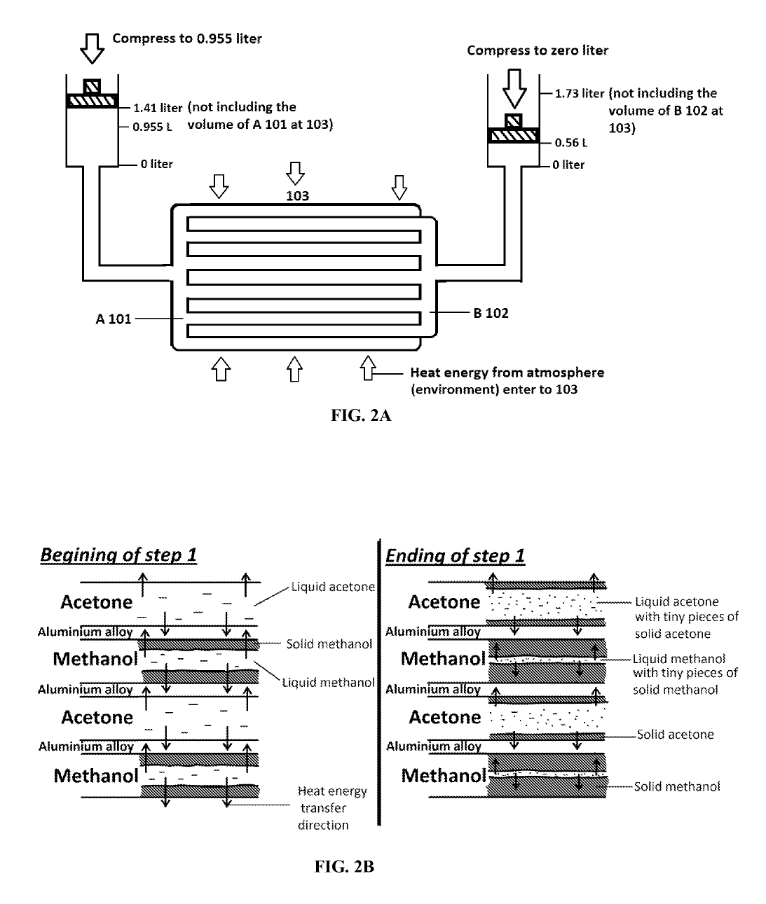

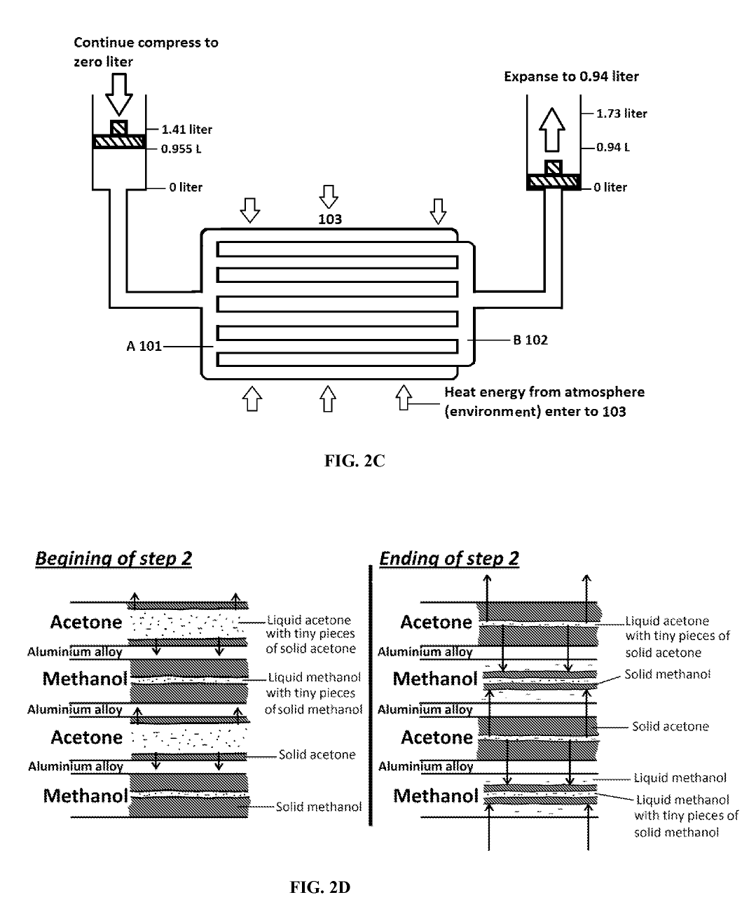

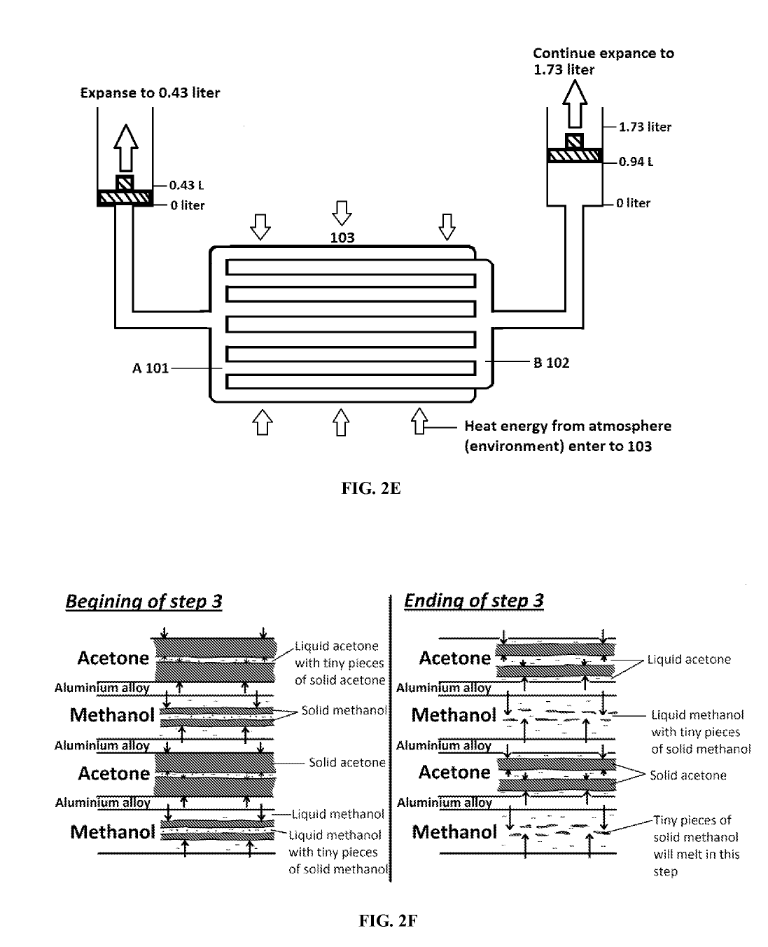

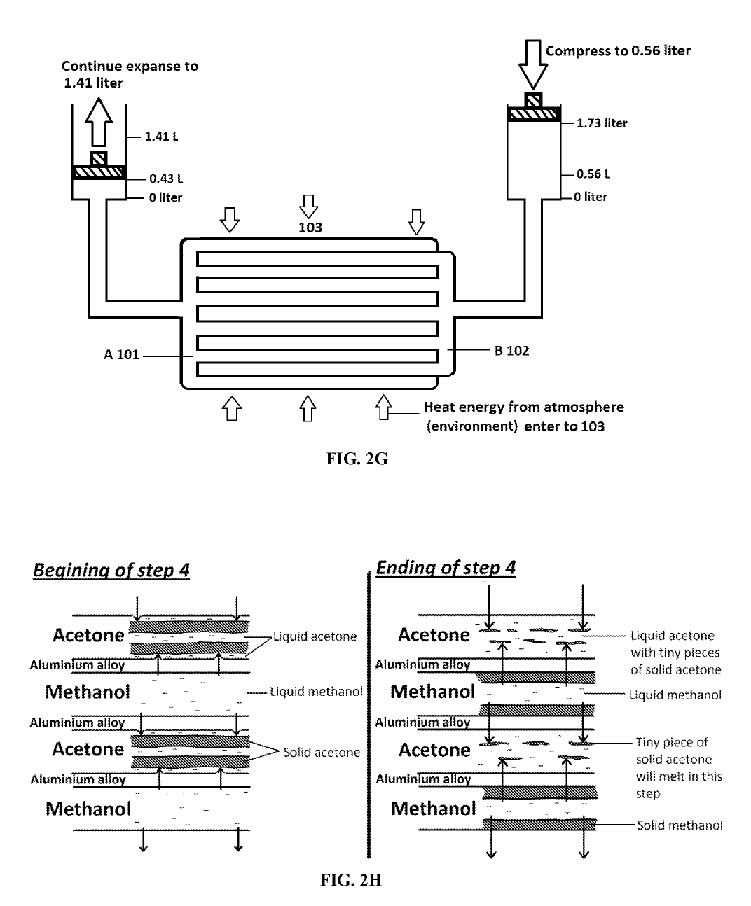

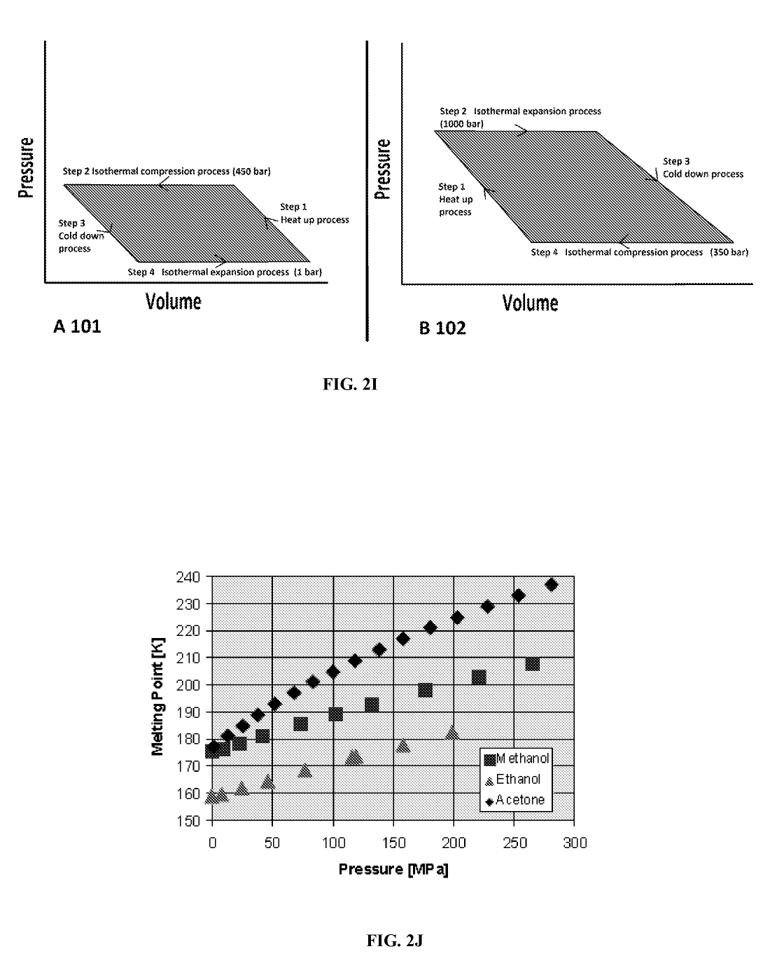

FIG. 2 is a schematic diagram depicting the functionality of systems and substances in use at cold heat engine 100, according to the embodiments as disclosed herein. As depicted in FIG. 2, label 1 show the piston and cylinder which compresses and expands substance A 101. Label 2 shows the piston and cylinder which compresses and expands substance B 102. Label 1 and Label 2 belong to the compression and expansion system where the cylinder and piston can be replaced by another device which has the same functionality and can match with the engine based on this method.

Label 1 and Label 2 can be replaced by the bag built by several layers of strong carbon fibre with the plastic layer at the inner layer because it does not possess the property of combustion. However, it can directly compress and expand the bag in order to let it compress and expand. This method is simple in construction and does not leak.

In an embodiment, substance A 101 can heat up and cool down itself and the substance contacting it. Substance A 101 also acts as the source which provides heat energy to the substance B 102 (working substance), when substance B 102 expands in volume in high temperatures. Substance A 101 also acts as the source which absorbs heat energy from substance B 102, when the substance B 102 is at the volume compression process in low temperature. By changing the pressure to this substance, the heat is generated and absorbed by volume compression and expansion. If substance A 101 is in the phase changing process, its latent heat also is the source which provides and absorbs heat energy. If substance A 101 stays in a single phase in the process, there occurs no transmission of latent heat.

Acetone and methanol are considered as the substances primarily used in the present invention. However, in some embodiments, substance A 101 need not necessarily be acetone. Substance A 101 can be any substance which can cooperate with working substance B 102 through this method to absorb heat energy from the environment, which is required to be converted to mechanical energy.

The substance B 102 can heat up and cool down itself and the substance which it contacts. The substance B 102 is also the working substance which absorbs heat energy from substance A 101 when it expands by volume at high temperature and lets substance A 101 absorb heat energy from it when it is in the volume compression process at low temperature. By changing the pressure to this substance, the heat is generated and absorbed by the volume compression and expansion. If in substance B 102, there is a phase change in process, the latent heat can also provide and absorb heat energy, and this does not happens if the substance B 102 stays in single phase in the process. The substance B 102 need not necessarily be methanol as earlier mentioned. In an embodiment, the substance B 102 can be any substance which cooperates with substance A 101 through this method in order to absorb heat energy from the environment and converts the heat energy to be absorbed to mechanical energy.

The substance B 102 is also like substance A 101, in certain cold heat engine 100, it not necessary phase change in the cycle of process, it can stay in single phase such as liquid or gas, where the key focus is on substance A 101 and substance B 102. The substance A 101 and substance B 102 can cooperate through this method to absorb heat energy from the environment and convert the heat energy to mechanical energy.

In the FIG. 2, the container containing substance A 101 and substance B 102 is built by high heat conductivity and strong material such as aluminium alloy, steel, carbon fibre and so on. For example, aluminium alloy can be chosen for the high efficiency of heat conductivity. The thickness of substance A 101, substance B 102, and the container wall should be extra thin. The key functions of the container are:
1. To isolate substance A 101 and substance B 102.
2. To ensure that the pressure change at substance A 101 and substance B 102 is not permanent for changing the container shape.
3. Possessing high heat conductivity to let substance A 101 and substance B 102 exchange the heat energy through the body.

The heat exchanger 103 device lets substance A 101 and substances B 102 exchange their heat energy and also absorb heat energy from the environment by its surface at the side.

Since the shape of the heat exchanger 103 is very flexible in design, it can also be the part of the cover or the body support structure of the vehicle at land, sea, sky and any other mode of transport or other purposes. The body of the heat exchanger 103 can be the part of the aircraft wing to reduce the weight of the aircraft, which is also similar to the shape of solar panels in order to have huge area contact to the radiation from the sun.

In an embodiment, the heat energy generated by the fuel (combustion) in petrol engine at the vehicle at instant wastes or loses about ±75% heat energy to atmosphere air through radiator and fan at the engine room. Only about 25% heat energy produced by fuel combustion can be converted by the engine to mechanical energy. If the running petrol engine does not continue to let go ±75% heat energy generated from the combustion of fuel which is not converted to mechanical energy and therefore the engine temperature will continue to increase until the engine burns out or jams.

In a cold heat engine 100, contrary to a heat engine, no heat energy is lost to the environment but is only absorbed from the environment and therefore all the heat energy of the cold heat engine 100 absorbed will be converted to mechanical energy. If the heat energy from the environment is not input to the cold heat engine 100, the engine 100 temperature will continue to decrease to the temperature where the engine 100 cannot function.

In an example, if a 120-horse power petrol engine and 120-horse power cold heat engine 100 are both running in 120 horsepower, each engine stays at the same volume sealed room. Initially at the beginning the rooms temperatures are the same in mean 20° C. and each engine maintains their optimum running temperature, where the oxygen at room temperature is enough to run petrol engine. After one minute, if the petrol engine increases the mean temperature of atmosphere air at the room to 29° C., the cold heat engine 100 just needs to decrease to the mean temperature of the atmosphere air at the room to 17° C.

This shows that the heat energy needed to exchange between atmosphere air and the cold heat engine 100 is just ⅓ of the heat energy needed to exchange between atmosphere air and the petrol engine. The cold heat engine 100 converts all input heat energy to mechanical energy without any wastage.

The radiator of the running petrol car engine is about 90° C. where it has about 69° C. temperature range with room temperature. In an embodiment, the heat exchanger 103 at the running cold heat engine 100 uses acetone and methanol as the substance A 101 and substance B 102. In this method of the present invention the mean temperature of the heat exchanger 103 at the engine 100 can be −88° C. and it has a 110° C. temperature change with respect to the room temperature. Further, there is also has 38° C. temperature range to let heat exchanger 103 continue to function with −50° C. atmosphere air. This phenomenon lets the cold heat engine 100 uses acetone and methanol as substance A 101 and substance B 102 can easily absorb heat energy from the environment through the atmosphere air where the size of the device allows to absorb heat energy from the atmosphere air which can be quite small than the radiator of the petrol car engine at that instant.

When the cold heat engine 100 is running at the atmosphere temperature above 0° C. then it is necessary to avoid steam inside the atmosphere air as it is condensed and freezes at places that can cause problems such as hindering the efficiency of the heat exchanger 103. The cold heat engine 100 can let the steam from the atmosphere air condensed or frozen at the place or device where the water or ice can be easily removed before the steam enters and condenses or freezes at the part of engine 100 which can cause problem.

Further, compared to absorb heat energy directly from the liquid, earth, and radiation and so on, it is normally not hard than absorb heat energy from atmosphere air, because the thermal conductivity of atmosphere air is lower than liquids and solids. In order to absorb heat energy from heat radiation, any material can turn heat radiation to heat energy which can be the source of heat energy to the cold heat engine 100, such as use the surface of heat exchanger 103 absorb the heat radiation.

### The Functioning of Cold Heat Engine 100 Using Acetone and Methanol as Substance A 101 and Substance B 102

In this method of the present invention, 22 kg of acetone is used as substance A 101 and 22 kg of methanol is used as substance B 102 in order to cooperate and absorb heat energy from the environment and to convert the heat energy to mechanical energy. This process allows for the conversion of heat energy to mechanical energy. Further, through this method if another suitable substance can cooperate to absorb heat energy from the environment and is responsible for converting the heat energy to mechanical energy, this substance can be considered as a possible alternative for substance A 101 and substance B 102.

Acetone and methanol are considered suitable choices for substance A 101 and substance B 102 since acetone and methanol at their normal melting point are cold enough to absorb heat energy from the surrounding environment at extremely cold temperatures in this earth. Also, acetone can change its melting point with a change in pressure where the pressure change need not be large enough for other many substances.

Methanol is a substance which possesses a melting point close to the normal melting point of acetone. There is a need for a large pressure change in order to match it to a different melting point at a different temperature. Although ideal gases such as hydrogen, helium and so on can replace methanol, these alternative substance for methanol needs to considerably expand and compress at a larger volume. Since this is not easy, methanol is the quite preferred choice for substance B 102. In this method of the present invention, the amount of substance A 101 and substance B 102 in use, pressure, temperature, heat up and cool down setting of acetone and methanol can be adjusted to achieve a different considerable output of mechanical energy.

FIGS. 2A and 2B are schematic diagrams depicting the functionality of cold heat engine 100 in step 1 which uses acetone as the substance A 101 and which uses methanol as the substance B 102.

### Step 1: Heat Up Process

At step 1, the heating up process occurs, where there is an increase in pressure for acetone and methanol corresponding to the increase in the temperature and the temperature of container containing them in the heat exchanger 103. Initially, acetone is compressed from 1 bar to 450 bar and methanol is compressed from 350 bar to 1000 bar to heat up their temperature. In this process at step 1, certain amounts of acetone and methanol freezes.

### Calculation of Heating Up Process of Acetone in Step One.

In acetone, compression process occurs from 1 bar to 450 bar. Except for the heat generated by compression, 4.9 kg of liquid acetone freeze and it latent heat is released in order to help to heat up 22 kg of acetone from the mean temperature of ±178.1K to 190.5K. This process also assists in the heating up of the container containing it from a temperature of 178.6 K to 190 K. In this step, 3.1×10³ J heat energy is absorbed from the atmospheric air to acetone.

Since the pressure increases, the melting point of acetone and melting point of methanol is considered to be at a higher temperature. If has the nucleus of freezing, the liquid does not continue to be in the liquid form below the melting point. At this point, the liquid has the nucleus of freezing must freeze so that the latent heat of freezing will heat up the liquid which not freeze yet at the surroundings to the melting point of that temperature. This will result in partly freezing acetone and methanol.

Factors forming a freezing nucleus are
a. Irregularity on the surface of the container containing liquid.
b. Impurities of liquid, which may be mixed up with another substance or dirty in nature.

The freezing on the surface of the container freezes in the bulk form caused by the need to share more latent heat to heat up the container. In the heating up process, liquid acetone and liquid methanol freezes at tiny tubes or similar structure inside the heat exchanger 103 can form tiny pieces of solid spread inside the liquid. This phenomenon speeds up the heating process because tiny pieces of solid acetone or methanol can quite average spread inside the liquid. Therefore, the latent heat is released or absorbed and this will heat up or cool down the liquid surroundings with a shorter distance.

### Equation for Step 1

The calculation of acetone compression work is split into two parts, part 1 for acetone will not freeze in this step, part 2 for acetone will freeze in this step.

### Part 1

$$〈 \frac{0.02}{0.913} - 0.0012 \times ( 191 - 178.1 ) 〉 \times \frac{1 + 450}{2} \times 9.8 \times {10}^{2} \times 0.1 \times \frac{22 - 4.9}{0.913} = {W}_{1} \approx 2.7 \times {10}^{3} J$$

### Part 2

1 kg liquid acetone freezes at 1 bar in the beginning

$$( \frac{0.913}{0.913} - \frac{0.913}{0.969} ) \times 1 \times 9.8 \times {10}^{2} \times 0.1 \times \frac{1}{0.913} = 6 J$$

1 kg liquid acetone compresses from 1 bar to 450 bar and freezes at 450 bar:

$$( \frac{0.913}{0.913} - \frac{0.913}{0.92} ) \times \frac{\frac{1 + 75}{2} + 450}{2} \times 9.8 \times {10}^{2} \times 0.1 \times \frac{1}{0.913} = 0.2 \times {10}^{3} J \\ ( \frac{0.913}{0.92} - \frac{0.913}{0.973} ) \times 450 \times 9.8 \times {10}^{2} \times 0.1 \times \frac{1}{0.913} = 2.6 \times {10}^{3} J$$

$$\frac{6 + ( 0.2 + 2.6 ) \times {10}^{3}}{2} \times 4.9 = {W}_{2} \approx 6.9 \times {10}^{3}$$

### Explanation to Data Use in Calculation at Part 1 and Part 2:

“0.02” (kg/10⁻³ m³) is density increase at 1 litre (kg/10⁻³ m³) acetone after 450 bar increase from 1 bar in maintain temperature at ±178K.

“0.0012” (10⁻³ m³) is the volume increased at 1 litre acetone when temperature increased 1° C. at ±180 K. It is isobaric coefficient of thermal expansion.

“0.913” (kg/10⁻³ m³) is the density of liquid acetone at ±177.6K in 1 bar.

“0.92” (kg/10⁻³ m³) is the approximate density of liquid acetone in 450 bar at 191K.

“9.8” (Joule) is Joule convert from 1 kgf·m.

“10²×0.1” is 100 cm² area from one surface of a 10⁻³ m³ equilateral cubic which have 0.1 m length at each side, it an unit of volume to acetone and methanol in calculation.

“0.969” (kg/10⁻³ m³) is density of solid acetone in 1 bar.

“0.973” (kg/10⁻³ m³) is approximate density of solid acetone in 450 bar.

“(1+75)/2” (bar) is the pressure increase at acetone at the beginning of this step which increases temperature gap between the liquid and solid acetone for efficiency of heat transfer. In this process, the amount of liquid acetone which freezes is lesser than the middle and rear term in this step.

“((1+75)/2+450)/2” (bar) is the mean pressure of acetone in compression process.

Except for the heat generated by the work at acetone compression process, the heat energy (Q) is also generated by the attractive force between the liquid acetone molecules

$$( 1985 - 1415 ) \times \frac{\frac{0.02}{0.913} - 0.0012 \times ( 191 - 178.1 )}{0.0012} \times ( 22 - \frac{4.9}{2} ) = Q \approx 6 \times {10}^{4}$$

“1985” (J/(kg·K)) is the specific heat at constant pressure of liquid acetone at ±178 K.

“1415” (J/(kg·K)) is the specific heat at constant volume of liquid acetone at ±178 K.

“(22−4.9/2)” (kg) is the 22 kg amount of liquid acetone and the 4.9 kg amount of liquid acetone which will freeze in this step.

“1” (kg) is the liquid acetone which does not freeze at all the steps.

In acetone compression process at this step, except for the heat energy produced by the work of compression and by the attractive forces between acetone molecules, 4.9 kg of liquid acetone is needed to freeze it to release the latent heat of freezing to help heat up 22 kg acetone (solid and liquid, including itself) from the mean temperature in the range of ±178.1K to ±190.5K and then supply 38% of heat energy to help heat up the 36 kg container which contains acetone and methanol at the heat exchanger 103 from mean temperatures of 178.6K to 190K.

$$\frac{9.83 \times {10}^{4} + ( 9.59 - 0.26 ) \times {10}^{4}}{2} \times 4.9 + {W}_{1} + {W}_{2} + Q + 3.1 \times {10}^{3} = 1535 \times \frac{4.9}{2} \times ( 190.5 - 177.6 ) + ( 22 - \frac{4.9}{2} ) \times 1430 \times ( 191 - 178.1 ) + 36 \times 850 \times ( 190 - 178.6 ) \times \frac{38}{100} \approx 5.42 \times {10}^{5} J$$

“9.83×10⁴” and “9.59×10⁴” (J/kg) is the latent heat of freezing of liquid acetone at 177.6K in 1 bar and at +191 K in 450 bar.

“0.26×10⁴” (J) is the work paid to maintain 450 bar at acetone volume changing in the freezing process at 191K, since this belongs to latent heat of freezing process at 191K in ±450 bar, W₂ is included.

“1535” (J/(kg·K)) is the specific heat of solid acetone at ±185 K.

“1430” (J/(kg·K)) is the specific heat at constant volume of liquid acetone at ±185 K.

“850” (J/(kg·K)) is the specific heat of aluminum alloy at ±185 K.

“(190.5-177.6)” and “(191-178.1)” (Kelvin) is mean temperature change range of solid acetone and liquid acetone.

“4.9/2” is the half amount of acetone change phase in this step

If the heat energy from the environment is first absorbed by either one of substance A 101 or substance B 102, then the heat energy will be eventually shared with another substance at the heat exchanger 103. In case the heat energy from the environment enters methanol and acetone in different amounts, then there needs to be a little bit of adjustment to the amount of methanol and acetone at cycle. When the engine 100 continues to provide the output of the mechanical energy then one or both of the substances A 101 and substance B 102 must continue to absorb heat energy from the environment in order to not let the engine 100 temperature drop under the engine 100 working temperature.

The heat energy from the environment is absorbed by substance A 101 and substance B 102 in each step which can make a difference. The factors affecting the absorption can be one of conductivity, convection, and temperature and so on.

### Calculation of the Volume Change of Acetone in Step One:

The calculation split into two parts, part 1 is for liquid acetone which maintains liquid state in this step, part 2 is for liquid acetone which will change phase to solid in this step.

### Part 1

$$17.1 \times 〈 \frac{0.02}{0.913} - 0.0012 \times ( 191 - 178.1 ) 〉 \times \frac{1}{0.913} = 0.12 L$$

### Part 2

$$\begin{matrix}4.9 \times ( \frac{0.913}{0.913} - \frac{0.913}{0.973} ) \times \frac{1}{0.913} = 0.331 L \\ = 0.12 + 0.331 \\ \approx \pm 0.451 L\end{matrix}$$

### Calculation of the Heat Up Process of Methanol in Step One:—

In the process of compression of methanol from 350 bar to 1000 bar, except for the heat generated by compression, 5.5 kg of liquid methanol freezes and the latent heat is released for freezing. This process is performed to help heat up 22 kg of methanol from a mean temperature of ±179.1 K to ±189 K and helps heats up the container containing them from a mean temperature of 178.6 K to 190 K. At the beginning of this step, 15.5 kg of solid methanol already exists and 1 kg of methanol does not freeze at any step.

In this step, 3.1×10³ J heat energy from atmosphere air (environment) enters to methanol.

The work payload for methanol compression in this step:

Split the calculation into three distinct parts, part 1 is where liquid methanol does not freeze, part 2 is where liquid methanol freezes, and part 3 is the existed solid methanol in beginning of this step.

### Part 1

$$〈 \frac{0.03}{0.915} - 0.0011 \times ( 189 - 179.6 ) 〉 \times \frac{1}{0.915} \times \frac{350 + 1000}{2} \times 9.8 \times {10}^{2} \times 0.1 = {W}_{1} \approx 1.6 \times {10}^{3} J$$

### Part 2

To freeze 1 kg liquid methanol at beginning in 350 bar:

$$( \frac{0.915}{0.915} - \frac{0.915}{0.983} ) \times 350 \times 9.8 \times {10}^{2} \times 0.1 \times \frac{1}{0.915} = 2.6 \times {10}^{3} J$$

To compress 1 kg liquid methanol from 350 bar to 1000 bar and freeze at 1000 bar:

$$( \frac{0.915}{0.935} - \frac{0.915}{0.988} ) \times 1000 \times 9.8 \times {10}^{2} \times 0.1 \times \frac{1}{0.915} = 5.6 \times {10}^{3} J \frac{2.6 + ( 1.6 + 5.6 )}{2} \times {10}^{3} \times 5.5 = {W}_{2} \approx 2.7 \times {10}^{4}$$

### Part 3

$$( \frac{0.983}{0.983} - \frac{0.983}{0.988} ) \times \frac{350 + 1000}{2} \times 9.8 \times {10}^{2} \times 0.1 \times \frac{1}{0.983} \times 15.5 = {W}_{3} \approx 5 \times {10}^{3} J$$

The heat energy generated by attractive forces between methanol molecules (liquid) which does not freeze and before freezing at methanol compression process in this step is:

$$( 2190 - 1770 ) \times \frac{\frac{0.03}{0.915} - 0.0011 \times ( 189 - 179.6 )}{0.0011} \times ( 1 + \frac{5.5}{2} ) = Q \approx 3.2 \times {10}^{4}$$

### Explanation to the Data Used in Calculation:

“0.03” (kg/(10⁻³ m³)) is the density increase at 1×10⁻³ m³ methanol from 350 bar to 1000 bar with maintained temperature at ±185 K.

“0.915” (kg/(10⁻³ m³)) is the density of methanol at 179.1K in ±350 bar.

“0.935” (kg/(10⁻³ m³)) is the approximate density of methanol at 189K in 1000 bar.

“0.0011” (10⁻³ m³) is volume change at 10⁻³ m³ volume of methanol when temperature changes 1° C. at 185 K. It is isobaric coefficient of thermal expansion.

“(350+1000)/2” is the mean pressure in bar.

“(350+450)/2” (bar) is the pressure increase in the early stages of methanol compression process, in this process the amount of liquid methanol freezing is lesser than the middle and rear terms in this step.

“5.5” (kg) is the amount of liquid methanol needed to freeze in this step.

“0.988” (kg/(10⁻³ m³)) is the approximate density of solid methanol at +189.5K in 1000 bar.

“0.983” (kg/(10⁻³ m³)) is the approximate density of solid methanol at +179.1K in 350 bar.

“2190” and “1770” J/(kg·K) is the specific heat at constant pressure and specific heat at constant volume of liquid methanol at ±179 K in 1 bar.

In methanol compression process at this step, except for the heat energy generated by the work payload in compression and by the attractive forces between liquid methanol molecules in compression process, 5.5 kg liquid methanol will freeze in this step. This is in order to release the latent heat of freezing to help heat up 22 kg methanol (solid and liquid, including itself) from mean temperature±179.1 K to 189 K at the heat exchanger 103. It also helps to provide 62% heat energy to heat up the 36 kg container containing acetone and methanol at the heat exchanger 103 from the mean temperature of 178.6 K to 190 K (the percentage of heat energy paid by methanol to heat up container can adjust with cooperate with acetone heat up process and another step).

The amount of liquid methanol needed to freeze in this step is 5.5 kg.

$$\frac{( 9.84 - 0.26 ) \times {10}^{4} + ( 9.36 - 0.55 ) \times {10}^{4}}{2} \times 5.5 + {W}_{1} + {W}_{2} + {W}_{3} + Q + 3.1 \times {10}^{3} = 15.5 \times 1670 \times ( 189 - 179.3 ) + 〈 \frac{5.5}{2} \times 1670 + ( 1 + \frac{5.5}{2} ) \times 1790 〉 \times ( 189 - 179.6 ) + 36 \times 850 \times ( 190 - 178.6 ) \times \frac{62}{100} \approx 5.74 \times {10}^{5}$$

### Explanation to the Data Used in Calculation:

“9.84×10⁴” and “9.36×10⁴” (J/kg) is the latent heat of freezing of methanol at +179.6K in 350 bar and at +189 K in 1000 bar.

“0.26×10⁴” and “0.55×10⁴” (J) is the work needed to maintain 350 bar and 1000 bar at 1 kg liquid methanol when it changes phase to solid in temperature±179.6K and ±189 K, it included in W₂.

“1670” J/(kg·K) is the specific heat of solid methanol at ±185 K.

“1790” J/(kg·K) is the specific heat at constant volume of liquid methanol at ±185 K.

“850” J/(kg·K) is the specific heat of aluminium alloy at ±185 K.

“(189-179.3)” and “(189-179.6)” (Kelvin) is the temperature change in the range of solid methanol and liquid methanol.

Calculation to the Volume of Methanol Needed to Decrease at this Step:

The calculation is split into three parts, part 1 for the liquid methanol does not freeze in this step, part 2 is for liquid methanol which freezes in this step, part 3 is for 15.5 kg solid methanol which already exists at the beginning and it is maintained as solid in this step.

### Part 1

$$1 \times 〈 \frac{0.03}{0.915} - 0.0011 \times ( 189 - 179.6 ) 〉 \times \frac{1}{0.915} = 0.02 liter$$

### Part 2

$$5.5 \times ( \frac{0.915}{0.915} - \frac{0.915}{0.988} ) \times \frac{1}{0.915} = 0.44 liter$$

### Part 3

$$15.5 \times ( \frac{0.983}{0.983} - \frac{0.983}{0.988} ) \times \frac{1}{0.983} \approx 0.1 liter$$

Sum: 0.02+0.44+0.1≈±0.56 liter

### APPENDIX

Process of acetone and methanol heating up and cooling down themselves in same time can shorten the process time, because it does not depend on one substance, it heats up and cool down together.

In heating up and cooling down process of acetone and methanol, a little amount of heat energy may be transferred between acetone and methanol; this has no influence to the result.

In this cycle, there is often a little amount of acetone and methanol at the outside of heat exchanger 103, such as at the tube between the heat exchanger 103 and compression chamber.

In this one cycle of the process (not in one step) of this present invention, the amount of acetone and methanol needed to enter the heat exchanger 103 or to go out from heat exchanger 103, the maximum amount here is about 1/16 and 1/13 of the amount inside the heat exchanger 103.

Through convection, heat conduction or other condition, the liquid acetone and liquid methanol outside the heat exchanger 103 can have very close temperature with acetone and methanol inside the heat exchanger 103, but it not necessary.

In this cycle, the liquid acetone and liquid methanol are released from the heat exchanger 103 (expansion process), they are not required to synchronize their temperature with the acetone and methanol inside heat exchanger 103. Their temperature can naturally repeat and follow the stable changing state at each step in the cycle, it not have bad influence to use this method to got mechanical energy.

In key mechanism of this method has no relevance to the releasing of the liquid acetone and liquid methanol from the heat exchanger 103 whether they can or cannot synchronize the temperature with acetone and methanol inside the heat exchanger 103.

### Step 2 Isothermal Expansion Process of Working Substance B 102 in High Temperatures and High Pressure

FIGS. 2C and 2D are schematic diagrams depicting the functionality of cold heat engine 100 in step two which uses acetone as the substance A 101 and which uses methanol as the substance B 102.

Step 2 is where the working substance B 102 (substance B) is in isothermal expansion process at high temperatures and high pressures (contrast to it compression process).

At step 2, 16.28 kg of solid methanol is melted by using the latent heat of freezing from 16.1 kg liquid acetone to overcome the latent heat of fusion of solid methanol.

This lets methanol to expand from solid volume to liquid volume in high temperatures and in high pressures. In this process, 16.28 kg solid methanol changes phase to liquid. The solid volume changes to liquid volume of methanol under 1000 bar in ±189 K and this is the critical mechanical energy given to this cold heat engine 100.

At this step, the mean temperature of liquid methanol gradually increases to ±0.7° C. caused by heat energy coming from acetone. The mean temperature of acetone and the container containing them at the heat exchanger 103 is maintained the same in this step (like many other setting, they can adjust with cooperation of another step).

The heat energy needed to heat up±0.7° C. the mean temperature of liquid methanol is:

(16.1+1)×2.14×10³×0.7=2.6×10⁴ J

“2.14×10³” J/(kg·K) is specific heat at constant pressure of liquid methanol at ±190 in 1000 bar.

When acetone and methanol are needed for heat conduction (exchange heat energy), the maximum and minimum temperature between methanol and acetone often has a ±2° C. temperature gap (range or distance) to conduct heat energy.

The Latent heat of fusion of solid methanol at 189 K in ±1000 bar at ±9.36×10⁴ J/kg.

The Latent heat of freezing of liquid acetone is at 191 K in ±450 bar is ±9.59×10⁴ J/kg.

When 16.28 kg solid methanol is changing phase to liquid, simultaneously acetone at 450 bar is maintained at 450 bar in order to let 16.1 kg of liquid acetone to freeze at ±191 K. This allows the release of latent heat to overcome the latent heat of fusion of 16.28 kg of solid methanol and heating up ±0.7° C. to the mean temperature of liquid methanol.

In this process a total of 3.1×2×10³ J of heat energy from the environment enters to acetone and methanol.

$$\frac{9.59 \times {10}^{4} \times 16.1 + 0.31 \times 2 \times {10}^{4} - 2.6 \times {10}^{4}}{9.36 \times {10}^{4}} = 16.28 kg$$

The work maintained at 450 bar for compression of 16.1 kg of liquid acetone from liquid volume to solid volume in this step is:

$$450 \times 9.8 \times {10}^{2} \times 0.1 \times ( \frac{0.913}{0.92} - \frac{0.913}{0.973} ) \times \frac{1}{0.913} \times 16.1 \approx 4.2 \times {10}^{4} J$$

The calculation of work obtained from expansion process from methanol in this step split to two parts, part one is for solid volume to liquid volume with maintain 1000 bar, part two is thermal expansion of liquid methanol.

### Part 1

$$1000 \times 9.8 \times {10}^{2} \times 0.1 \times ( \frac{0.988}{0.936} - 1 ) \times \frac{1}{0.988} \times 16.28 = 9 \times {10}^{4} J$$

### Part 2

$$1000 \times 9.8 \times {10}^{2} \times 0.1 \times ( 1 - \frac{0.935}{0.935 + 0.0005} ) \times \frac{1}{0.935} \times 16.28 \approx 1 \times {10}^{3} J$$

“0.0005” (10⁻³ m³/K) is the 1 liter liquid methanol's approximate coefficient of thermal expansion at 1000 bar at ±190K.

Calculate the volume of acetone needed to decrease (compress) at this step.

$$16.1 \times ( \frac{0.913}{0.92} - \frac{0.913}{0.973} ) \times \frac{1}{0.913} \approx \pm 0.955 liter$$

Calculate the volume of methanol needed to increase (expanse) at this step.

$$16.28 \times ( \frac{0.915}{0.935} - \frac{0.915}{0.988} ) \times \frac{1}{0.915} + 0.0005 \times 16.28 \approx \pm 0.94 liter$$

### Step 3 Cool Down Process

FIGS. 2E and 2F are schematic diagrams depicting the functionality of cold heat engine 100 in step 3 which uses acetone as the substance A 101 and which uses methanol as the substance B 102.

Step 3 signifies the cooling down process, through decreasing the pressure by expansion of acetone and methanol to cool down their temperature and the temperature of the container which contains them. At this process, except for the heat energy to be absorbed by volume expansion of acetone and methanol, the latent heat of fusion of melting solid acetone and solid methanol will absorb heat energy to help cool down the temperature.

In this step, 3.1×10³ J heat energy from atmosphere air (environment) enters to acetone and methanol.

At this step, the mean temperature of methanol drops from +189.5 K to 179.6 K at this step.

### Calculation of Methanol in Cool Down Process in Step 3

The work output obtained from methanol expansion at this step is:

Split the calculation into three parts: part 1 is for liquid methanol which is already in the liquid state at the beginning of this step, part 2 is for liquid methanol which melts from solid methanol at this step, part 3 is for the expansion of solid methanol before it melts.

### Part 1

$$〈 \frac{0.0305}{0.915} - 0.0011 \times ( 189.7 - 179.6 ) 〉 \times \frac{1000 + 350}{2} \times 9.8 \times {10}^{2} \times 0.1 \times \frac{17.28}{0.915} = {W}_{1} \approx 2.8 \times {10}^{4}$$

### Part 2

For 1 kg solid methanol to be melted at beginning of this step in 1000 bar and to expand from 1000 bar to 350 bar after melting from solid to liquid:

$$( \frac{0.915}{0.935} - \frac{0.915}{0.988} ) \times 1000 \times 9.8 \times {10}^{2} \times 0.1 \times \frac{1}{0.915} = 5.6 \times {10}^{3} J \\ ( \frac{0.915}{0.915} - \frac{0.915}{0.935} ) \times \frac{1000 + 350}{2} \times 9.8 \times {10}^{2} \times 0.1 \times \frac{1}{0.915} = 1.5 \times {10}^{3} J$$

For 1 kg of solid methanol to be melted at end of this step in 350 bar:

$$( \frac{0.915}{0.915} - \frac{0.915}{0.983} ) \times 350 \times 9.8 \times {10}^{2} \times 0.1 \times \frac{1}{0.915} = 2.6 \times {10}^{3} J$$

The expansion work of part 2 is:

$$\frac{( 5.6 + 1.5 ) + 2.6}{2} \times {10}^{3} \times ( 21 - 16.28 ) = {W}_{2} \approx 2.3 \times {10}^{4} J$$

### Part 3

Expansion work from 1 kg solid methanol to be melted at beginning of this step is zero, since the solid is melted at beginning of this step.

Expansion work of 1 kg solid methanol to be melted at the middle term of this step.

$$( \frac{0.988}{0.983 + \frac{0.988 - 0.983}{2}} - 1 ) \times \frac{1000 + \frac{1000 + 350}{2}}{2} \times 9.8 \times {10}^{2} \times 0.1 \times \frac{1}{0.988} \approx 2 \times {10}^{2} J$$

Expansion work of 1 kg solid methanol to be melted at end of this step.

$$( \frac{0.988}{0.983} - 1 ) \times \frac{1000 + 350}{2} \times 9.8 \times {10}^{2} \times 0.1 \times \frac{1}{0.988} \approx 3 \times {10}^{2} J$$

Expansion work in part 3 is:

$$( 0 + 2 + 3 ) \times {10}^{2} \times \frac{1}{3} \times 4.72 = {W}_{3} \approx 8 \times {10}^{2} J$$

Total work obtained from expansion of methanol in these three parts is:

(2.8+2.3+0.1)×10⁴≈5.2×10⁴ J

Except for the heat energy absorbed by the work obtained at the methanol expansion process in the expansion process, heat energy is also absorbed by the methanol molecules against attractive forces between methanol molecules in expansion process (potential energy between molecules methanol increase by volume expansion).

The heat energy of the absorption is:

$$( 2190 - 1770 ) \times \frac{\frac{0.0305}{0.915} - 0.0011 \times ( 189.7 - 179.6 )}{0.0011} \times ( 16.28 + 1 + \frac{4.72}{2} ) = Q \approx 1.67 \times {10}^{5}$$

### Explanation to the Data Used in Calculation:

“16.28” (kg) is the liquid methanol existing in the beginning of this step.

“4.72” (kg) is the solid methanol existing in the beginning of this step.

“189.7” (Kelvin) is the temperature of liquid methanol increasing 0.7° C. from 189 K at step 2.

Except for the other factor of cooling down of methanol calculated in this step, the latent heat of fusion from 4.72 kg solid methanol also helps cools down the temperature of methanol and the container containing them. Combining all the factors of methanol cool down in this step, the methanol can cool down itself from 189.5 K to 179.6 K, where it also can absorb 74.8% heat energy from container containing acetone and methanol (itself) to cool down from mean temperature 190 K to 178.6K.

$$\frac{( 9.84 - 0.26 ) \times {10}^{4} + ( 9.36 - 0.55 ) \times {10}^{4}}{2} \times 4.72 + {W}_{1} + {W}_{2} + {W}_{3} + Q - 3.1 \times {10}^{3} = \frac{4.72}{2} \times ( 1790 + 1670 ) \times ( 189 - 179.6 ) + ( 16.28 + 1 ) \times 1790 \times ( 189.7 - 179.6 ) + 36 \times 850 \times ( 190 - 178.6 ) \times \frac{74.8}{100} \approx 6.5 \times {10}^{5} J$$

Calculation to the Volume of Methanol Needed to Increase (Expanse) at this Step:

Calculation is split to two parts, part 1 is the liquid methanol already existing in beginning of this step, part 2 is for the solid methanol which will melt in this step.

### Part 1

$$17.28 \times 〈 \frac{0.0305}{0.915} - 0.0011 \times ( 189.7 - 179.6 ) 〉 \times \frac{1}{0.915} = 0.42 liter$$

### Part 2

$$4.72 \times ( \frac{0.915}{0.915} - \frac{0.915}{0.988} ) \times \frac{1}{0.915} = 0.381 liter$$

Sum: 0.42+0.381≈±0.8 liter

Many explanation of data used in calculations from step 1 to step 4 is the same with explanation use in step 1.

### Calculation of Acetone in Cool Down Process at Step 3

In step three, when methanol expands and melts to cool down, acetone also expands and melts to cool down simultaneously. In acetone melting and expansion process, acetone absorbs heat energy to cool down the temperature from 190 K to +178.1 K and this helps absorb (100−74.8) % heat energy from the container containing them (acetone and methanol) to cool down the container from 190 K to 178.6 K. At the beginning of this step, 1 kg of liquid acetone exists and 5.34 kg solid acetone to be melts at this step.

During this step, 3.1×10³ J heat energy from the environment is passed on to the acetone.

First calculate the work that one can get from acetone expansion and in the melting process of this step:

The calculation is split into four parts, part 1 is for liquid acetone already existing in the liquid state at beginning of this step (only 1 kg), part 2 is for liquid acetone melted from solid acetone in this step, part 3 is for the expansion of solid acetone before they melt in this step, part 4 is for expansion of solid acetone which does not melt in this step.

### Part 1

$$〈 \frac{0.02}{0.913} - 0.0012 \times ( 191 - 178.1 ) 〉 \times \frac{1 + 450}{2} \times 9.8 \times {10}^{2} \times 0.1` \times \frac{1}{0.913} = {W}_{1} \approx 2 \times {10}^{2} J$$

### Part 2

For 1 kg of solid acetone to be melted at (450-50) bar in the beginning of this step and expanding from 400 bar to 1 bar after melting from solid state.

$$( \frac{0.913}{0.92} - \frac{0.913}{0.973} ) \times ( 450 - 50 ) \times 9.8 \times {10}^{2} \times 0.1 \times \frac{1}{0.913} = 2.3 \times {10}^{3} J \\ ( \frac{0.913}{0.913} - \frac{0.913}{0.92} ) \times \frac{400 + 1}{2} \times 9.8 \times {10}^{2} \times 0.1 \times \frac{1}{0.913} = 0.2 \times {10}^{3} J$$

For 1 kg of solid acetone to be melted at end of this step.

$$( \frac{0.913}{0.913} - \frac{0.913}{0.969} ) \times 1 \times 9.8 \times {10}^{2} \times 0.1 \times \frac{1}{0.913} = 6 J$$

$$\frac{( 2.3 + 0.2 ) \times {10}^{3} + 6}{2} \times 5.34 = {W}_{2} \approx 7 \times {10}^{3}$$

### Part 3

Expansion work from 1 kg of solid acetone to be melted at beginning of this step is zero, because solid acetone is melted at the beginning.

Expansion work from 1 kg solid acetone to be melted at middle term of this step:

$$( \frac{0.973}{0.969 + \frac{0.973 - 0.969}{2}} - \frac{0.973}{0.973} ) \times \frac{450 + \frac{450 + 1}{2}}{2} \times 9.8 \times {10}^{2} \times 0.1 \times \frac{1}{0.973} \approx 70 J$$

Expansion work from 1 kg solid acetone to be melted at the end of this step:

$$( \frac{0.973}{0.969} - \frac{0.973}{0.973} ) \times \frac{450 + 1}{2} \times 9.8 \times {10}^{2} \times 0.1 \times \frac{1}{0.973} \approx 90 J$$

Total work at part 3 is:

$$\begin{matrix}( 0 + 70 + 90 ) \times \frac{1}{3} \times 5.34 = {W}_{3} \\ \approx 3 \times {10}^{2}\end{matrix}$$

### Part 4

$$( \frac{0.973}{0.969} - \frac{0.973}{0.973} ) \times \frac{450 + 1}{2} \times 9.8 \times {10}^{2} \times 0.1 \times \frac{1}{0.973} \times ( 21 - 5.34 ) = {W}_{4} \approx 1.5 \times {10}^{3}$$

“(450-50)” (bar) is the pressure drop from 450 bar to 400 bar in acetone expansion process with less solid acetone melts in this term (front term) compared with other terms in this step. This because the mean temperature of acetone at beginning drops that the heat energy absorbed by container containing is in lower temperature than acetone at beginning (front term) of this step.

“21” (kg) is the amount of solid acetone existing in beginning of this step.

Except for the heat energy absorbed by the work obtained in acetone expansion process, the heat energy also absorbed by acetone molecules against attractive force between acetone molecules in expansion process (potential energy between molecules of acetone increase by volume expansion).

### The Heat Energy of the Absorption Process is:

$$( 1988 - 1415 ) \times \frac{\frac{0.02}{0.913} - 0.0012 \times ( 191 - 178.1 )}{0.0012} \times ( 1 + \frac{5.34}{2} ) = Q \approx 1.1 \times {10}^{4}$$

Except for the other cooling down factor calculated in this step, the latent heat of fusion from 5.34 kg solid acetone also helps to cool down the temperature of acetone and the container containing them (acetone and methanol). Combining all the factor of acetone cooling down itself, temperature of acetone drops from ±190.5 K to +178.1 K, which also can absorb (100−74.8) % heat energy from container containing them (acetone and methanol) in order to cool down from mean temperature of 190 K to 178.6 K.

$$\frac{9.83 \times {10}^{4} + ( 9.59 - 0.26 ) \times {10}^{4}}{2} \times 5.34 + {W}_{1} + {W}_{2} + {W}_{3} + {W}_{4} + Q - 3.1 \times {10}^{3} = < ( 16.1 - \frac{5.34}{2} ) \times ( 191 - 177.6 ) + 4.9 \times ( 190.5 - 177.6 ) > \times 1535 + ( 1 + \frac{5.34}{2} ) \times 1430 \times ( 191 - 178.1 ) + 36 \times 850 \times ( 190 - 178.6 ) \times \frac{25.2}{100} \approx 5.29 \times {10}^{5} J$$

“<(16.1−5.34/2)×(191−177.6)+4.9×(190.5−177.6)>×1535” is the total specific heat stored from 16.1 kg solid acetone from 177.6 K to 191 K with 5.34 kg solid acetone gradually being melted in this temperature range and from where 4.9 kg solid acetone from 177.6 K to 190.5 K which was frozen in step 1. The 16.1 kg solid acetone was frozen at 191 K in step 2.

“1535” J/(kg·K) is the specific heat of solid acetone around ±185 K.

“25.2” (%) is the percentage of heat energy stored inside container containing acetone and methanol from 178.6 K to 190 K which needs to be absorbed by acetone in the cool down process of this step (step 3). This is because the methanol cool down process in this step absorbs 74.8% heat energy from the container from 178.6 K to 190 K. The percentage of heat energy from the container needed to absorb by acetone in this step can be adjusted with the cooperation of another step in cycle.

Calculation of volume of acetone needed to increase (expanse) at this step: Split the calculation into three parts, part 1 is solid acetone to be melted in this step, part 2 is liquid acetone already existing in beginning of this step, part 3 is solid acetone not melted in this step.

$$5.34 \times ( \frac{0.913}{0.913} - \frac{0.913}{0.973} ) \times \frac{1}{0.913} = 0.361 liter$$

### Part 1

### Part 2

$$1 \times < \frac{0.02}{0.913} - 0.0012 \times ( 191 - 178.1 ) > \times \frac{1}{0.913} = 0.007 liter$$

### Part 3

$$15.66 \times ( \frac{0.973}{0.969} - \frac{0.973}{0.973} ) \times \frac{1}{0.973} = 0.066 liter$$

Sum: 0.361+0.007+0.066≈±0.43 liter

### Step 4 Isothermal Compression Process of Working Substance B 102 in Low Temperature and Low Pressure

FIGS. 2G and 2H are schematic diagrams depicting the functionality of cold heat engine 100 in step 4 which uses acetone as the substance A 101 and which uses methanol as the substance B 102.

At Step 4 the working substance (substance B 102) is in isothermal compression process in low temperatures and at low pressure. In this step, latent heat of fusion is used from solid acetone to freeze 15.5 kg liquid methanol (overcome latent heat of freezing of 15.5 kg liquid methanol). In this process, 15.5 kg liquid methanol will change phase from liquid to solid and the liquid volume will change to solid volume with the pressure maintained at 350 bar in ±179.6 K (isothermal compression process in low temperatures).

In meantime, 15.66 kg solid acetone will change phase from solid to liquid. The solid volume will change to liquid volume with the pressure maintained at 1 bar in ±177.6 K. In this step, total 2×3.1×10³ J heat energy from environment is passed to acetone and methanol.

Mean temperature of 15.5 kg solid methanol gradually decreases by 0.3° C. in this step. Mean temperature of acetone and the container containing acetone and methanol does not change in this step (like early mention, these can adjust with another step).

The heat energy needed to absorb for decreasing 0.3° C. mean temperature of solid methanol is:

15.50×1660×0.3=0.8×10⁴ J

Latent heat of fusion of solid acetone at 177.6 K in 1 bar is ±9.83×10⁴ J/kg.

Latent heat of freezing of liquid methanol at 179.6 K in 350 bar is ±9.84×10⁴ J/kg.

In the process of 15.5 kg liquid methanol change phase to solid, 15.66 kg solid acetone need to melted at +177.6 K and 1 bar to release it latent heat of fusion to overcome the latent heat of freezing of methanol. 15.66 kg solid acetone latent heat of fusion also need to decrease 0.3° C. mean temperature of solid methanol in process. In process have total 6.2×10³ J heat energy from environment enter to acetone and methanol.

$$\frac{15.5 \times 9.84 \times {10}^{4} + 0.8 \times {10}^{4} + 0.62 \times {10}^{4}}{9.83 \times {10}^{4}} \approx 15.66 kg$$

The work paid to maintain 350 bar at methanol change from liquid volume to solid volume is:

$$350 \times 9.8 \times {10}^{2} \times 0.1 \times ( \frac{0.983}{0.915} - \frac{0.983}{0.983} ) \times \frac{1}{0.983} \times 15.5 = 4 \times {10}^{4} J$$

The work obtained from expansion of solid acetone to change its volume from solid to liquid is:

$$1 \times 9.8 \times {10}^{2} \times 0.1 \times ( \frac{0.913}{0.913} - \frac{0.913}{0.969} ) \times \frac{1}{0.913} \times 15.66 = 1 \times {10}^{2} J$$

Calculate the volume of methanol needed to decrease (compress) at this step:

$$15.5 \times ( \frac{0.915}{0.915} - \frac{0.915}{0.983} ) \times \frac{1}{0.915} = \pm 1.17 liter$$

Calculate the volume of acetone needed to increase (expand) at this step:

$$15.66 \times ( \frac{0.913}{0.913} - \frac{0.913}{0.969} ) \times \frac{1}{0.913} = \pm 0.99 liter$$

Summing up the work payload and obtained from step 1 to step 4 in the cycle of method of the present invention which uses acetone and methanol as substance A 101 and substance B 102.

$$< \overbrace{( - 1 - 3.4 )}^{step 1} + \overbrace{( - 4.2 + 9.1 )}^{step 2} + \overbrace{( 0.9 + 5.1 )}^{step 3} + \overbrace{( - 4 )}^{step 4} > \times {10}^{4} \approx 2.5 \times {10}^{4} J$$

Through one cycle of the process (step 1 to step 4), about 2.5×10⁴ J mechanical energy is earned, this fixes the amount of heat energy absorbed from the environment by a mechanism based on this method. The amount of heat energy absorbed from environment is:

8×3.1×10³≈2.5×10⁴ J

FIG. 21 shows PV diagrams depicting the functionality of cold heat engine 100 which uses acetone as the substance A 101 and which uses methanol as the substance B 102 whereas FIG. 2J depicts the effect of pressure to melting point at acetone and methanol. FIG. 2J is obtained from “Effect of Pressure on the Melting Point” by Dr. Kevin G. Joback at Molecular Knowledge Systems, Inc.

Cold heat engine 100 depicts two PV diagrams, the first is PV diagram of the substance A 101, the second is the PV diagram of substance B 102 (working substance), which depicts the work of acetone and methanol in this cycle of process. Different substances A 101 and substance B 102 depict the different shape of PV diagrams. The coloured area is the sum work of acetone and methanol in each substance, where the substance A 101 depicts input, and the substance B 102 (working substance) depicts output.

### Efficiency of Cold Heat Engines 100 to Use Acetone and Methanol as the Substance A 101 and Substance B 102

One of the keys for the efficiency of the cold heat engine 100 is dependent on the heat transfer speed in each step of this method, the factors influencing heat transfer speed are:
1. Heat conductivity of substance A 101, substance B 102 and the container wall isolates substance A 101 and substance B 102 at the heat exchanger 103.
2. The thickness of substance A 101, substance B 102, and the container wall isolate Substance A 101 and substance B 102. The Smaller thickness can transfer heat energy in shorter distance and have bigger areas transfer heat energy in the same volume at heat exchanger 103.
3. Area of substance A 101, substance B 102 and other related thing use to heat transfer.
4. The temperature range between substance A 101 and substance B 102 are in process when they need to exchange their heat energy, further there is a higher temperature range which has higher efficiency where they can transfer heat energy.
5. Convection. Convection is considered to increase the heat transfer speed.

In an embodiment, the calculation of the efficiency of heat energy at this engine 100 uses acetone and methanol which is considered as the substance A 101 and substance B 102. Firstly, it is required to set the thickness of acetone and methanol inside the heat exchanger 103, here it is set at 0.1 mm, the thickness of wall container isolates substance A 101 and substance B 102 inside the heat exchanger 103 is set at around ±0.015 mm.

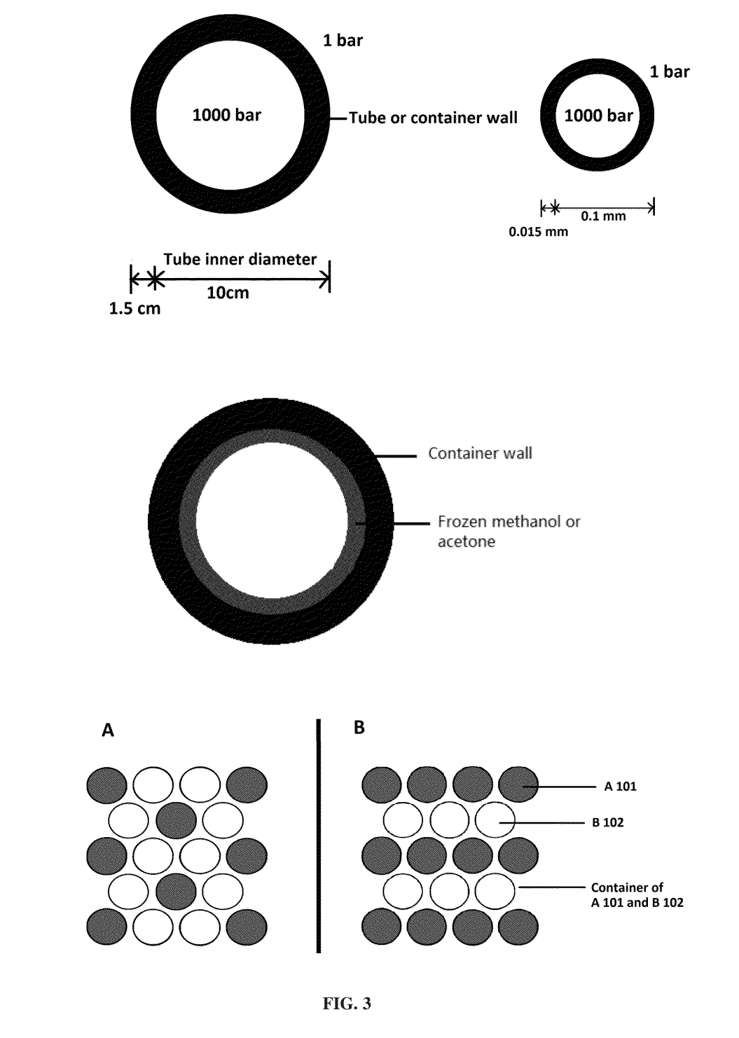

FIG. 3 is a schematic diagram depicting how the small and thin aluminium alloy tube contains high pressure substance inside the heat exchanger 103, according to the embodiments as disclosed herein.

If the ratio of high pressure tube in the inner diameter and the thickness of the tube wall is in the right ratio then even the wall is consider thinner than 0.01 mm, it still can contain high pressure substance. The main challenge of the cold heat engine 100 is how to mass produce the heat exchanger 103 which comprises a large number of tiny tubes or other similar structures with thin walls to isolate and contain the substance A 101 and substance B 102. In an embodiment, the factory may fuse the contact part of two slides of aluminium alloys foils which is full with tiny order concave and convex surfaces through compression and the electric power or heat energy. This process can enable large amount of tiny room between the two foils. If in case between these two sides of aluminium alloy foil there is another slide of thin aluminium alloy foil which has an even surface and it focuses to conduct heat energy to the centre of the tube or tiny room between the foils, then it fuses the contact part of this three slide foil, this structure is to enable high heat conductive ability to the substance contained inside it.

For the calculation of the efficiency of the heat energy transfer in this set method, it is necessary to use acetone and methanol which is considered as the substance A 101 and substance B 102 to be the substances calculated for the efficiency of heat transfer. Here, the calculation of heat transfer can be neglected for the aluminium alloy which isolates and contains acetone and methanol because it has about 210 W/(m·K) heat conductivity which is considered to be higher±1000 times than the heat conductivity of the liquid acetone and liquid methanol. For heat transfer calculation, it is necessary to focus on the substances that have low heat conductivity in heat exchange process inside the heat exchanger 103. For example liquid acetone and liquid methanol has a heat conductivity of ±0.2 w/(m·K). The heat conductivity of the solid state is around 2.5 times more than the liquid state. Substances in different temperatures and pressures have different heat conductivity.

In order to calculate the efficiency of the heat transfer in this cycle at this set method of present invention which uses acetone and methanol to be the substance A 101 and substance B 102, ±4.1×10⁶ J is the heat energy required to transfer inside acetone and between acetone and substances surrounding it which contact acetone. The heat energy generated and absorbed by acetone and methanol used in heating up and cooling down is no transfer required, including “Q” and certain “W” in calculation at step 1 and step 3.

Although it is very minimal compared to the total heat energy state which needs transfer, the heat energy from environment includes the heat energy required to transfer.

Heat energy of acetone required to transfer in each step:

### Step 1

±4.8×10⁵ J

### Step 2

±1.54×10⁶ J

### Step 3

±5.2×10⁵ J

### Step 4

±1.54×10⁶ J

Sum: (0.48+1.54+0.52+1.54)×10⁶≈4.1×10⁶ J

Further, ±4×10⁶ J is the heat energy needed to transfer inside methanol and between methanol and substances surrounding it which contact methanol, it does not include the heat energy generated and absorbed which is used in heat up and cold down themselves, like “Q” and certain amount of “W” in calculation at step 1 and step 3. The heat energy from environment also needs to calculate, although it is very minute compared to the total heat energy.

±4×10⁶ J comes from:

### Step 1

±5.4×10⁵ J

### Step 2

±1.52×10⁶ J

### Step 3

±4.5 ×10⁵ J

### Step 4

±1.53×10⁶ J

Sum: (0.54+1.52+0.45+1.53)×10⁶ J≈4×10⁶ J

Step 2 and step 4 are considered as the heat exchange processes between acetone and methanol (substance A 101 and substance B 102) so that the amount of heat energy needs transfer between them is same. Step 1 and step 3 is the heat up and cold down process, they heat up and cool down themselves and the substance contacts it at surroundings. Therefore, in the calculation the efficiency of heat transfer at cold heat engine 100 uses acetone and methanol which is the substance A 101 and substance B 102, it is required to pick one of them which has the most low heat conductivity and needs to calculate the efficiency of transfer sufficient heat energy.

The heat conductivity of acetone and methanol is considerably close, in calculation and it is necessary to pick the substance required to transfer sufficient amount of heat energy, here chosen the acetone be the substance to calculate the efficiency of this cold heat engine 100. The amount of heat energy required to transfers at acetone and methanol can be adjusted to have a shorter process time and it depends on the engine 100 setting of each step in the cycle.

The balanced heat energy transfer distance between acetone and methanol in liquid state is +0.009 mm and this is used to calculate the efficiency of this engine 100 since this balance distance have most low heat conductivity. When acetone and methanol need heat exchange, then from one side it must be able to transfer heat energy through the solid state to liquid state at another side and in calculation. This calculation is to focus on the heat conductivity of the liquid and the setting of ±0.009 mm balances distance of heat transfer of acetone and methanol in liquid state since the freezing and melting process does not always occurs at the centre of the tube, further the volume close to centre is small compared to the volume close to the side. The amount of solid acetone or solid methanol melts at close to the tube wall are much larger than the amount melted at close to centre of the tube, and the average distance between the tube wall and the solid acetone or solid methanol in melting process is about +0.009 mm.

$${0.05}^{2} π \times \frac{15.8}{21} \times \frac{1}{2} \approx {0.05}^{2} π - {( 0.05 - 0.0105 )}^{2} π$$

“0.05̂2 π×15.8/21×1/2” is the half of the mean vertical area of acetone and methanol which is melted in step 2 and step 4.
“0.0105” (mm) is the approximate mean distance between tube wall and solid acetone or solid methanol through their liquid state which is melted in step 2 and step 4.

The mean heat transfer distance at liquid acetone and liquid methanol is regarding heat up and cold down process which is the difference than step 2 and step 4, the distance range is not as far as compared than step 2 and step 4 and the heat energy needs to transfer through the liquid which is lesser than step 2 and step 4. So it can set the mean heat energy transfer mean distance between acetone and methanol in liquid state to ±0.009 mm.

### Area of Heat Conduction in Calculation

Calculation of the Heat Transfer Area of Acetone:

$$( 1 \times \frac{1}{0.92} + 21 \times \frac{1}{0.973} ) \times \frac{1}{1000} \times \frac{1}{0.0001} \times \frac{π}{2} \approx 356 {m}^{2}$$

“1×1/0.92” (10⁻³ m³) is the volume of 1 kg acetone in ±450 bar at ±190 K inside heat exchanger 103.

“21×1/0.973”(10⁻³ m³) is the volume of 21 kg acetone in solid state at ±450 bar at ±190 K inside heat exchanger 103.

“1/1000” is liter to m³.

“1/0.0001” (m) is the thick of acetone in heat exchanger 103.

“π/2” is the mean perimeter of liquid acetone which surrounds the solid acetone in a tube (or similar structure) in cycle of process.

In heat transfer, if the container has a heat conductivity which is very high than the substance A 101 and substance B 102, the arrangement at A and B at inside FIG. 3 does not have a big influence to heat transfer speed.

In a cycle, the maximum and minimum temperature inside acetone and methanol often has a 2° C. range in heat up and cold down process. This occurs when acetone and methanol needs heat energy exchange and where the maximum and minimum temperature between acetone and methanol also often has a 2° C. The heat conductivity of acetone and methanol in their solid state is about 2.5 times stronger than their liquid state, so the temperature range at acetone or methanol in liquid state is about:

$$2 \times \frac{2.5}{2.5 + 1} \approx 1.43 °C .$$

1.43° C. is because when high heat conductivity substance and low heat conductivity substance transfer heat energy through their connected body, and then if their size is same or close then the temperature range of high heat conductivity substance is smaller than the temperature range at the low heat conductivity substance. The temperature range is dependent on the transfer distance and the heat conductivity of the substance. 1.43° C. is the temperature range used in the calculation of efficiency of heat transfer in this engine 100 which uses acetone and methanol to be the substance A 101 and substance B 102 in this present invention.

Calculation of efficiency of cold heat engine 100 use different thick of acetone and methanol inside heat exchanger 103 and influence of convection to heat transfer

The heat transfer formula is:

$$Q = kA \frac{{T}_{2} - {T}_{1}}{l} t$$

Q=Amount of heat energy transfer.

k=Heat conductivity of the substance, unit is W/(m·K).

A=Area of substance use in heat transfer, unit is m².

T₂−T₁=Temperature range of the substance transfer heat.

l=Thick of the substance which heat energy transfer through it, unit is meter.

t=Time used in heat transfer, unit is second.

Calculation to the time take by one cycle of this cold heat engine 100 which use “0.1 mm” thick of acetone and methanol layers (tiny cylinders shape or other shape) inside heat exchange 103 in this presentation.

$$Q = kA \frac{{T}_{2} - {T}_{1}}{l} t$$

$$4.1 \times {10}^{6} = 0.2 \times 356 \times \frac{1.43}{0.000009} t$$

$$t \approx 0.36$$

With no calculation to the influence of convection, the time take by one cycle of this engine 100 is 0.36 second, so this engine 100 can output 2.5×10⁴×1/0.36=6.94×10⁴ J mechanical energy in one second, it equal to 6.94×10⁴ Watts.

6.94×10⁴ Watts is the maximum power of a normal car, about 93 horsepower.

If we use convection to let liquid acetone and liquid methanol can transfer heat energy fast like their solid state, this cold heat engine 100 at least can give about 1.09×10⁵ Watts mechanical energy.

This calculation is based on heat energy transfer where the speed of liquid is same to their solid state.

$$4.1 \times {10}^{6} = 0.5 \times 356 \times \frac{2}{0.00002} t$$

$$t \approx 0.23$$

$$2.5 \times {10}^{4} \times \frac{1}{0.23} = 1.09 \times {10}^{5} Watts$$

1.09×10⁵ Watts is the maximum power of a quite powerful cars which have 146 horsepower.

This show the convection of substance A 101 and substance B 102 inside heat exchanger 103 can greatly increase the efficiency of cold heat engine 100.

Convection has natural convection and the force convention which are the main two types such as natural wind in the atmosphere and wind from fan at petrol engine room. With condition the force convection is easily increase the heat transfer speed to above 2.5 times. Based on the size of the tube which contains and isolates acetone and methanol, it is very small inside the heat exchanger 103 even liquid acetone and liquid methanol moving very slow which can cause strong convection. Another condition is the minimum and maximum temperature at acetone and methanol at process in cycle it often has 2° C. in heat convection process, which is an important condition for convection too.

This shows that except pressure and temperature, the convection can also control the cold heat engine 100 running speed in this present invention, here the focus is on how this method can absorb heat energy and the heat energy is converted to mechanical energy.

If the cold heat engine 100 uses 0.08 mm thickness of acetone and methanol layers inside the heat exchanger 103 which does not calculate any influence of the convection in the cycle process, the power of the engine 100 is:

First calculate the area of acetone used in heat transfer:

$$( 1 \times \frac{1}{0.92} + 21 \times \frac{1}{0.973} ) \times \frac{1}{1000} \times \frac{1}{0.00008} \times \frac{π}{2} = 445 {m}^{2}$$

Efficiency of heat transfer:

$$4.1 \times {10}^{6} = 0.2 \times 445 \times \frac{1.43}{0.0000072} t$$

$$t \approx 0.23$$

Power of this cold heat engine 100 is:

$$2.5 \times {10}^{4} \times \frac{1}{0.23} = 1.09 \times {10}^{5} Watts$$

1.09×10⁵ Watts is the maximum power of a quite powerful car which have 146 horse power.

Acetone and methanol only thin 1/5 than 0.1 mm, the efficiency of this cold heat engine 100 increase from 6.94×10⁴ watts to 1.09×10⁵ Watts, its increase rate is about 57% of the cold heat engine 100 used 0.1 mm thick of acetone and methanol.

This shows that lesser the thickness of substance A 101 and substance B 102 inside the heat exchanger 103, the efficiency of cold heat energy 100 can increase higher.

Absorption of Heat Energy from the Environment to the Heat Exchanger 103

Absorbing heat energy from the atmosphere to the heat exchanger 103 is an important task of the cold heat engine 100. If the heat energy from the environment enters to the part of the heat exchanger 103 which the volume considered not sufficient, since it can cause problems to the cold heat engine 100 to use certain substance A 101 or substance B 102 or both (acetone and methanol for example) inside the heat exchanger 103 which absorbs the heat energy from the environment.

To this part of heat exchanger 103, the process at cycle may fail to work as the heat energy from the environment is extra for the small part of the heat exchanger 103 and therefore will cause the necessary freezing process not to occur or to be in an incomplete form. This process can also gradually influence the whole substance A 101 and substance B 102 inside the heat exchanger 103.

To avoid this phenomenon, it is important to have the mechanism to let heat energy from environment enter to the sufficient part of heat exchanger 103.

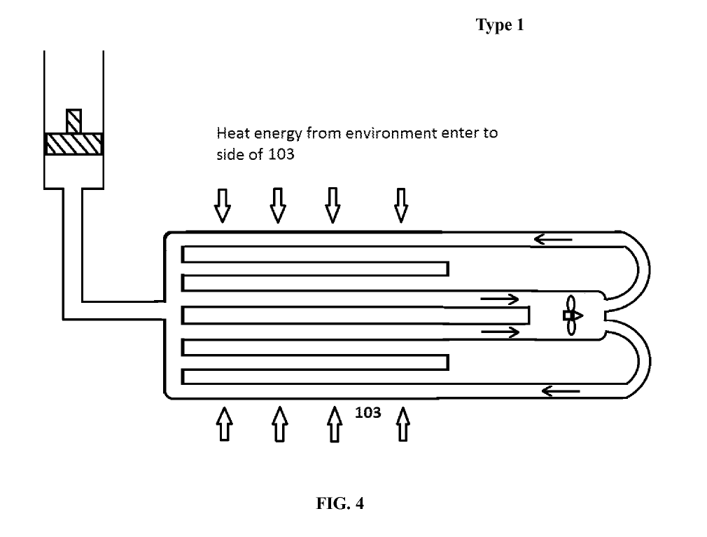

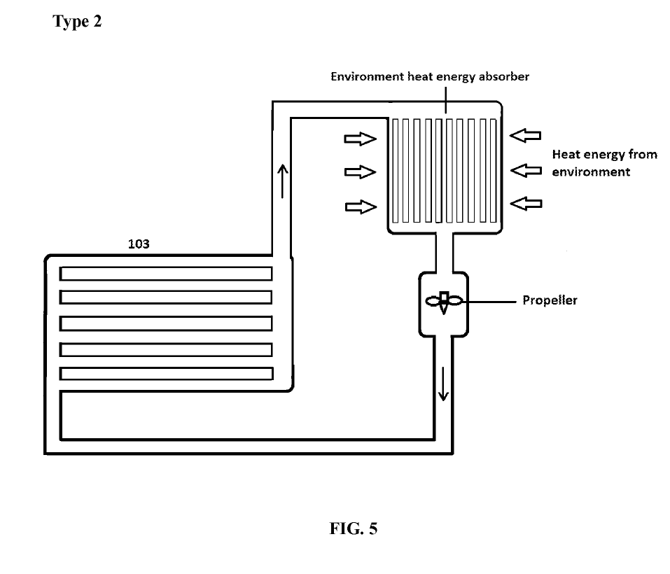

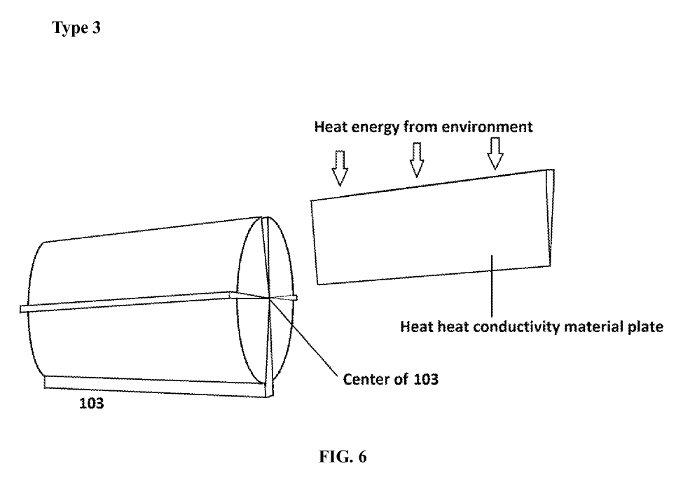

FIG. 4 is a schematic diagram of the type 1 heat exchanger 103 of the present invention, according to the embodiments as disclosed herein. As depicted in FIG. 4, in order to let the heat energy from environment enter to the sufficient part of heat exchanger 103, the engine 100 comprises some devices such as propeller, diaphragm, piston or other similar devices to let the substance A 101 or substance B 102 close to the surface of heat exchanger 103 which already absorbs heat energy from the environment flow inside the heat exchanger 103. This is done in order to exchange the acetone and methanol inside the heat exchanger 103, especially acetone and methanol at the centre area and bring heat energy to the area close to the centre.

FIG. 5 is a schematic diagram of the type 2 heat exchanger 103 of the present invention, according to the embodiments as disclosed herein. Since the fluid needs to absorb heat energy from the environment through the environment heat absorber, then the fluid needs to bring back the heat energy to the heat exchanger 103.

Further, except for another suitable substance to the fluid, the fluid can be the substance A 101 and substance B 102 which can be directly connected or not connected to the substance A 101 and substance B 102 in the heat exchanger 103. The key mechanism is that the fluid can bring back heat energy to sufficient part of the heat exchanger 103.

FIG. 6 is a schematic diagram of the type 3 heat exchanger 103 of the present invention, according to the embodiments as disclosed herein. If the heat exchanger 103 is thin in size, the high heat conductivity material plate or similar device at heat exchanger 103 can bring the heat energy absorb from the environment at the side to the centre area of heat exchanger 103. In this heat transfer route, the conducting heat energy will spread to the surrounding substance which contacts it at inside heat exchanger 103.

For the engine 100, it can be of a mix type where it need not only use one type of way to enter the heat energy from the environment. The engine 100 can be used in a plurality of ways at an instant to enter heat energy from the environment to the sufficient part of the heat exchanger 103.

Type 1 to Type 3 heat exchangers 103 is normally suitable to absorb heat energy from the environment at this earth. In order to absorb heat energy directly from solids like land, the engine 100 can use high conductivity material closely connected with land to conduct or to bring the heat energy into the heat exchanger 103 of the engine 100. In order to absorb energy from radiation, it is first necessary to convert the radiation to heat energy such as converting electromagnetic waves to the heat energy by a material which can absorb electromagnetic waves. This can then conduct or bring the heat energy into the heat exchanger 103.

The Ways Start the Cold Heat Engine 100 when the Engine 100 Temperature is the Same or Close to Environment Temperature

It depended on what the substance A 101 and substance B 102 of the cold heat engine 100 use.

Consider that the cold heat engine 100 temperature is the same or close to the environment temperature and if the substance A 101 and substance B 102 of the cold heat engine 100 can cooperate absorb heat energy and convert the heat energy to mechanical energy which shows that the cold heat engine 100 can start running at that temperature. In this case if the substance A 101 and substance B 102 cannot cooperate to absorb heat energy and convert the heat energy to the mechanical energy then this cold heat engine 100 does not start running at that temperature. In this case ideal gases considered as substances which can cooperate in a flexible temperature.

In the cold heat engine 100, acetone and methanol is used as substance A 101 and substance B 102 in the method of the present invention. This engine 100 can only work at temperatures of acetone and methanol at the heat exchanger 103 which is close to the state of any process in cycle. In case, if acetone and methanol stay in the state which is the beginning of step 1 and therefore the temperature must be close to 179 K. Although, it is possible to adjust the pressure on acetone and methanol and to increase the melting point and freezing point, this is considered a substantial temperature range above the optimum running temperature and therefore it is hard to generate mechanical energy anymore, further reason is the pressure is considered very high to the container containing acetone and methanol at the heat exchanger 103.

If this cold heat engine 100 which used acetone and methanol as the substance A 101 and substance B 102 in the method of the present invention is little higher than the engine 100 optimum running temperature, the process of cycle base on this method allows absorbing heat energy from acetone and methanol at the heat exchanger 103 to cool down their temperature to optimum running temperature.

The engine 100 can be used in the similar way such as the household refrigerator which can maintain a low temperature in the inside.

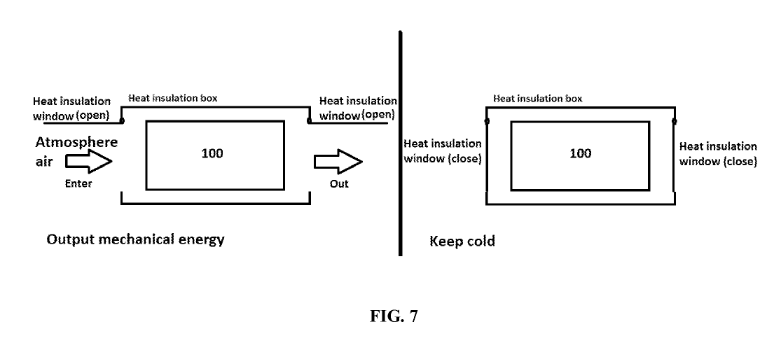

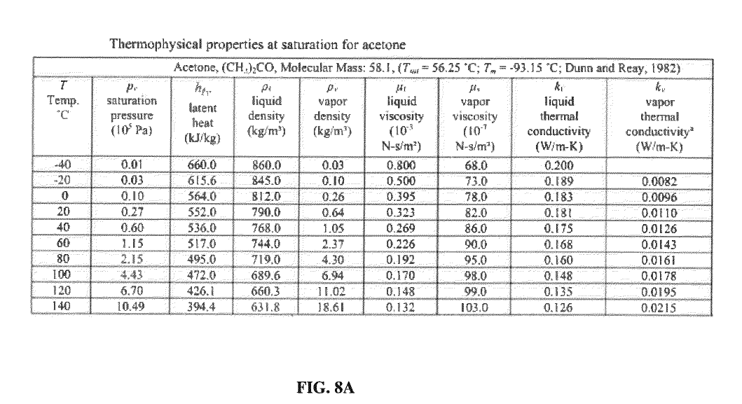

FIG. 7 is a schematic diagram depicting the method of the cold heat engine 100 keep cold, according to the embodiments as disclosed herein. The engine 100 can be contained inside the good heat insulation box which comprises good insulation windows to allow atmosphere air enter and go out from the engine 100 in order to provide heat energy to the heat exchanger 103 when the engine 100 needs output mechanical power. When the engine 100 does not require output mechanical energy, the heat insulation windows closes to keeps the coldness away from the environment temperature. The engine 100 can automatically run for a while in order to absorb heat energy from engine 100 and to drop down the engine 100 temperature which may have increased slightly.

The engine 100 may prepare slight excess of solid acetone and solid methanol which are the substance A 101 and substance B 102 at heat exchanger 103 to let them melt in order to maintain temperature of the substance A 101 and substance B 102. When all the excess solid acetone and excess solid methanol is melted, the engine 100 automatically starts running to freeze the excess acetone and excess methanol. After freezing the excess acetone and methanol, the engine 100 needs to stop and wait to freeze the melted excess acetone and methanol. Except substance A 101 and substance B 102, the engine 100 can use another suitable substance to use this way to keep engine 100 temperature in cold state.

In another way the engine 100 may slowly unstop running to maintain the temperature in the cold state.

With zero fuel and electric consumption and zero emission, the engine 100 can be kept in cold state.

If the engine 100 is split to ten independent units or more, when the temperature of engine 100 same or close to the environment it is required to cool down one independent unit of the heat exchanger 103 of the engine 100 which is specially designed for this situation. When it cools down to the running temperature and the state is set to the right condition then it can start running to absorb the heat energy to cool down another unit of the engine 100. When another unit of the engine 100 reaches the running condition, it may have more than one unit to absorb heat energy to cool down another unit of the engine 100 until all the units of the engine 100 can run. The engine 100 can use another device especially to cool down the small independent unit of engine 100 to the engine 100 working temperature.

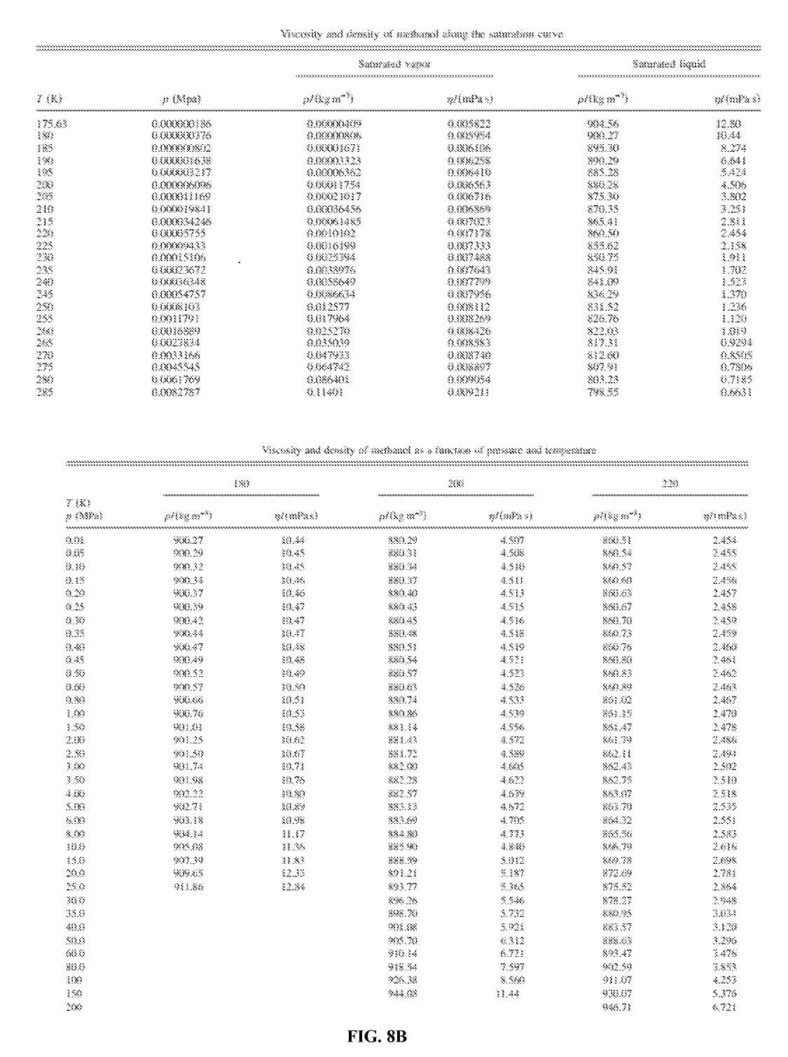

FIGS. 8A and 8B depict the table representations and readings for the influence of viscosity at acetone and methanol. FIG. 8A is obtained from “APPENDIX B TRANSPORT PROPERTIES” from thermalfluidscentral.org/e-books whereas FIG. 8B is obtained from “A New Reference Correlation for the Viscosity of Methanol” by Hong Wei Xiang, Arno Laesecke, and Marcia L. Huber at Physical and Chemical Properties Division, National Institute of Standards and Technology, Boulder, Colo. 80305.

Inside the engine 100 running in the present invention, the volume of acetone and methanol needs to go out and get in at heat exchanger 103 at minimal amounts. The maximum viscosity close to the freezing points is about ten times higher than water and above 25 times lower than typical motor oil and therefore the viscosity is low. In running engine 100, the work paid to overcome viscosity of acetone and methanol is dependent on the structure of the container which contains acetone and methanol. This includes the properties of the container wall surface contained inside the heat exchanger 103. If one of the tube seals at the rear side which contains acetone or methanol for heat exchange inside the heat exchanger 103 is 10 cm length, the acetone and methanol at front side of the tube only needs to go in and go out less than 1 cm length in one cycle of this engine 100.

In case shorter length tube is used to exchange heat energy inside the heat exchanger 103 then the length of acetone and methanol moving in and moving out of the tube at the front of the tube section becomes shorter, their velocity of flow also becomes slower.

The calculation of the present invention does not include the calculation of viscosity since it can be quite small. The heat energy generated by the work payload against viscosity at the heat exchanger 103 is absorbed by the engine 100 which is converted to mechanical energy. The heat energy generated by the friction of the engine 100 can also be absorbed by the engine 100 and converted to mechanical energy if the heat can be transferred to the heat exchanger 103.

The SI physical unit of dynamic viscosity is the pascal-second (Pa·s).

Water at 20° C. has a viscosity about 0.001002 Pa·s, while a typical motor oil have viscosity about 0.250 Pa·s.

Water at 20° C. has a viscosity of 1.0020 cP.

1P=0.1 Pa·s

1 cP=1 mPa·s=0.001 Pa·s=0.001N·s/m²

Equations to calculate latent heat and compression heat at different temperature and pressure

Equation to find the latent heat of fusion to various pure substances at different temperature and pressure

$${L}_{f} = {L}_{f , 1 bar} - ( {c}_{{P}_{m , solid}} - {c}_{{V}_{m , liquid}} ) \times ( {T}_{2} - {T}_{1} ) - ( {c}_{{P}_{m}} - {c}_{{V}_{m}} ) \times \frac{{V}_{1} - {V}_{2}}{{y}_{m} \times {V}_{1}} + P \times ( {V}_{2} - {V}_{s} )$$

L_{f}=Latent heat of fusion at the temperature and pressure which you want to find substance latent heat.

L_{f,1bar}=Latent heat of fusion at 1 bar.

c_{P}_{_{m,solid}}=Mean solid specific heat at constant pressure of the substance from T₁ to T₂.

c_{V}_{_{m,liquid}}=Mean liquid specific heat at constant volume of substance from T₁ at 1 bar to T₂ with the pressure you want find it latent heat.

T₁=Temperature of melting point at 1 bar.

T₂=Temperature at the substance melting point which you want to find it latent heat of fusion.

Vₛ=Solid volume of the substance at T₂ and in the pressure which you want to find it latent heat of fusion.

V₁=Liquid volume at 1 bar in T₁.

V₂=Liquid volume in T₂ and at the pressure which you want to find the substance's latent heat of fusion (freezing).

yₘ=Mean coefficients of volume expansion of the substance at liquid state at V₁ to V₂ in maintain 1 bar (if the volume of liquid is in supercool state, it can use approximate data base on it Coefficients of expansion changing rate with temperature).

c_{P}_{ₘ}=Mean specific heat at constant pressure of substance in liquid state at volume V₁ to V₂ in maintain 1 bar (if the volume of liquid is in supercool state, it can use approximate data base on it c_{P} changing rate with temperature).

c_{V}_{ₘ}=Mean specific heat at constant volume of substance in liquid state at V₁ to V₂ in maintain 1 bar (if the volume of liquid is in supercool state, it can use approximate data base on it c_{V} changing rate with temperature).

P=Pressure at the substance's melting point which you want to find it latent heat of fusion.

### Explanation to how the Equation Determines the Latent Heat of Fusion to Various Pure Substances at Different Temperature and Pressure.

In the energy balance theory in physics, the latent heat of fusion must match the part 1, part 2 and part 3 at equation below.

$${L}_{f} = {L}_{f , 1 bar} - ( {c}_{{P}_{m , solid}} - {c}_{{V}_{m , liquid}} ) \times ( {T}_{2} - {T}_{1} ) - ( {c}_{{P}_{m}} - {c}_{{V}_{m}} ) \times \frac{{V}_{1} - {V}_{2}}{{y}_{m} \times {V}_{1}} + P \times ( {V}_{2} - {V}_{s} )$$

Part 1, −(c_{P}_{_{m,solid}}−c_{V}_{_{m,liquid}})×(T₂−T₁)

Part 1 is the total heat capacity gap between solid and liquid state of the substance from T₁ to T₂.

$$Part 2 , - ( {c}_{{P}_{m}} - {c}_{{V}_{m}} ) \times \frac{{V}_{1} - {V}_{2}}{{y}_{m} \times {V}_{1}}$$

Part 2 is the total heat energy generate by the substance in liquid state when compress it from V₁ to V₂. This part calculates the heat energy generate from attractive force between the atoms or molecules of the substance in compression process.

Part 3, +P×(V₂−Vₛ)

Part 3 is the work payload to maintain the pressure when the liquid volume changes to solid volume at the temperature and pressure which you want to find the substance latent heat.

Note: This equation is not suitable to abnormal liquids which have solid volume bigger than liquid volume, like water, silicon and etc.

Latent heat of fusion (or freezing) based on this equation which is used in calculation

Based on the equation, the latent heat of fusion of methanol at 189K in 1000 bar is about:

(The compressibility of liquid methanol at 189K from 1 bar to 1000 bar is ±5% compare with it volume before compression.)

$${L}_{f} = 9.9 \times {10}^{4} - ( 1650 - 1785 ) \times ( 189 - 175.3 ) - ( 2190 - 1770 ) \times \frac{\frac{0.905}{0.905} - \frac{0.905}{0.936}}{0.0011 \times 1} + 1000 \times 9.8 \times {10}^{2} \times 0.1 \times ( \frac{0.905}{0.936} - \frac{0.905}{0.988} ) \times \frac{1}{0.905} = ( 9.9 + 0.18 - 1.27 + 0.55 ) \times {10}^{4} \approx 9.36 \times {10}^{4} J \text{/} kg$$

The latent heat of fusion of methanol at 179.6K in 350 bar is about:

$${L}_{f} = 9.9 \times {10}^{4} - ( 1630 - 1775 ) \times ( 179.6 - 175.3 ) - ( 2193 - 1770 ) \times \frac{\frac{0.905}{0.905} - \frac{0.905}{0.914}}{0.0011 \times 1} + 350 \times 9.8 \times {10}^{2} \times 0.1 \times ( \frac{0.905}{0.914} - \frac{0.905}{0.983} ) \times \frac{1}{0.905} = ( 9.9 + 0.06 - 0.38 + 0.26 ) \times {10}^{4} \approx 9.84 \times {10}^{4} J \text{/} kg$$

The latent heat of fusion of acetone at 191K in 450 bar is about:

(The compressibility of acetone at 191K from 1 bar to 450 bar is ±2.2%)

$${L}_{f} = 9.83 \times {10}^{4} - ( 1535 - 1430 ) \times ( 191 - 177.6 ) - ( 1983 - 1415 ) \times \frac{\frac{0.913}{0.913} - \frac{0.913}{0.92}}{0.0012 \times 1} + 450 \times 9.8 \times {10}^{2} \times 0.1 \times ( \frac{0.913}{0.92} - \frac{0.913}{0.973} ) \times \frac{1}{0.913} = ( 9.83 + 0.14 - 0.36 + 0.26 ) \times {10}^{4} \approx 9.59 \times {10}^{4} J \text{/} kg$$

Equation to find the amount of temperature change at liquid adiabatic compression or expansion process

$$Δ T = < ( {c}_{{P}_{m}} - {c}_{{V}_{{m}_{1}}} ) \times \frac{{V}_{1} - {V}_{2}}{{y}_{m} \times {V}_{1}} + {P}_{m} \times ( {V}_{1} - {V}_{2} ) > \times \frac{1}{{c}_{{V}_{{m}_{2}}}}$$

ΔT=Total temperature change

c_{P}_{ₘ}=Mean specific heat at constant pressure of substance in liquid state at V₁ to V₂ in maintain beginning pressure (if the volume of liquid is in supercool state, it can use approximate data based on its c_{P} changing rate with temperature).

$${c}_{{V}_{{m}_{1}}}$$

=Mean specific heat at constant volume of substance in liquid state at V₁ to V₂ in maintain beginning pressure (if the volume of liquid is in supercool state, it can use approximate data based on it c_{V} changing rate with temperature).

$${c}_{{V}_{{m}_{2}}}$$

=Mean specific heat at constant volume of substance in liquid state from beginning temperature and pressure to final temperature and pressure (if the volume of liquid is in supercool state, it can use approximate data base on it c_{V} changing rate with temperature and pressure).

V₁=Volume before change.

V₂=Volume after changed with temperature and pressure changed.

yₘ=Mean coefficient of volume thermal expansion (contraction) of liquid at V₁ to V₂ in maintain beginning pressure (if the volume of liquid is in supercool state, it can use the approximate data).

Pₘ=Mean pressure at process of volume change.

Note: This equation not suitable to abnormal liquids which have solid volume big than liquid volume, like water, silicon and etc.

Equations to determine the amount of temperature change at liquid compression or expansion process when it heat energy share with other substances

$$Δ T = < ( {c}_{{P}_{m}} - {c}_{{V}_{{m}_{1}}} ) \times \frac{{V}_{1} - {V}_{2}}{{y}_{m} \times {V}_{1}} + {P}_{m} \times ( {V}_{1} - {V}_{2} ) > \times \frac{1}{{c}_{{V}_{{m}_{2}}} + Q}$$

ΔT=Total temperature change.

c_{P}_{ₘ}=Mean specific heat at constant pressure of substance in liquid state at V₁ to V₂ in maintain beginning pressure (if the volume of liquid is in supercool state, it can use approximate data based on it c_{P} changing rate with temperature).

$${c}_{{V}_{{m}_{1}}}$$

=Mean specific heat at constant volume of substance in liquid state at V₁ to V₂ in maintain beginning pressure (if the volume of liquid is in supercool state, it can use approximate data based on it c_{V} changing rate with temperature).

$${c}_{{V}_{{m}_{2}}}$$

=Mean specific heat at constant volume of substance in liquid state from beginning temperature and pressure to final temperature and pressure (if the volume of liquid is in supercool state, it can use approximate data based on it c_{V} changing rate with temperature and pressure).

V₁=Volume before change.

V₂=Volume after changed with temperature and pressure changed.

yₘ=Mean coefficient of volume thermal expansion (contraction) of liquid at V₁ to V₂ in maintain beginning pressure (if the volume of liquid is in supercool state, it can use the approximate data).

Pₘ=Mean pressure at process of volume change.

Q=Heat energy output or input (absorb).

Note: This equation is not suitable to abnormal liquids which have solid volume big than liquid volume, like water, silicon and etc.

### Equation to Find the Amount of Heat Energy Generated and Absorbed by Liquid Compression and Expansion Process

$$Δ Q = < ( {c}_{{P}_{m}} - {c}_{{V}_{m}} ) \times \frac{{V}_{1} - {V}_{2}}{{y}_{m} \times {V}_{1}} + {P}_{m} \times ( {V}_{1} - {V}_{2} ) >$$

ΔQ=Total heat energy change.

c_{P}_{ₘ}=Mean specific heat at constant pressure of substance in liquid state at V₁ to V₂ in maintain beginning pressure (if the volume of liquid is in supercool state, it can use approximate data based on it c_{P} changing rate with temperature).

c_{Vm}=Mean specific heat at constant volume of substance in liquid state at V₁ to V₂ in maintain beginning pressure (if the volume of liquid is in supercool state, it can use approximate data based on it c_{V} changing rate with temperature).

V₁=Volume before change.

V₂=Volume after changed with temperature and pressure increased.

yₘ=Mean coefficient of volume thermal expansion (contraction) of liquid at V₁ to V₂ in maintain beginning pressure (if the volume of liquid is in supercool state, it can use the approximate data).

Pₘ=Mean pressure at process of volume change.

Note: This equation not suitable to abnormal liquids which have solid volume bigger than liquid volume, like water, silicon and so on.

### Equations to Find the Amount of Heat Energy Generated and Absorbed by Attractive Force Between Liquid Atoms or Molecules at Liquid Compression and Expansion Process

$$Δ Q = ( {c}_{{P}_{m}} - {c}_{{V}_{m}} ) \times \frac{{V}_{1} - {V}_{2}}{{y}_{m} \times {V}_{1}}$$

ΔQ=Total heat energy change.

c_{P}_{ₘ}=Mean specific heat at constant pressure of substance in liquid state at V₁ to V₂ in maintain beginning pressure (if the volume of liquid is in supercool state, it can use approximate data based on it c_{P} changing rate with temperature).

c_{V}_{ₘ}=Mean specific heat at constant volume of substance in liquid state at V₁ to V₂ in maintain beginning pressure (if the volume of liquid is in supercool state, it can use approximate data based on it c_{V} changing rate with temperature).

V₁=Volume before change.

V₂=Volume after changed with temperature and pressure increased.

yₘ=Mean coefficient of volume thermal expansion (contraction) of liquid at V₁ to V₂ in maintain beginning pressure (if the volume of liquid is in supercool state, it can use the approximate data).

Note: This equation not suitable to abnormal liquids which have solid volume big than liquid volume, like water, silicon and etc.

### Process Calculation of the Cold Heat Engine 100 by Using Water and Compressed Atmospheric Air be the Substance A 101 and Substance B 102

### Step One is Heating Up Process

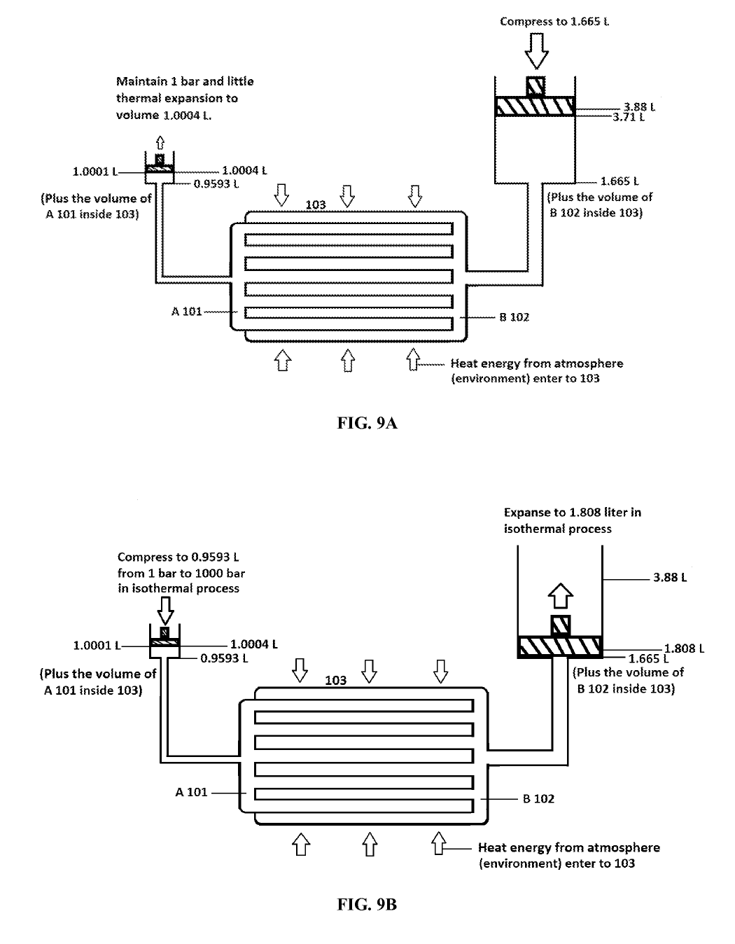

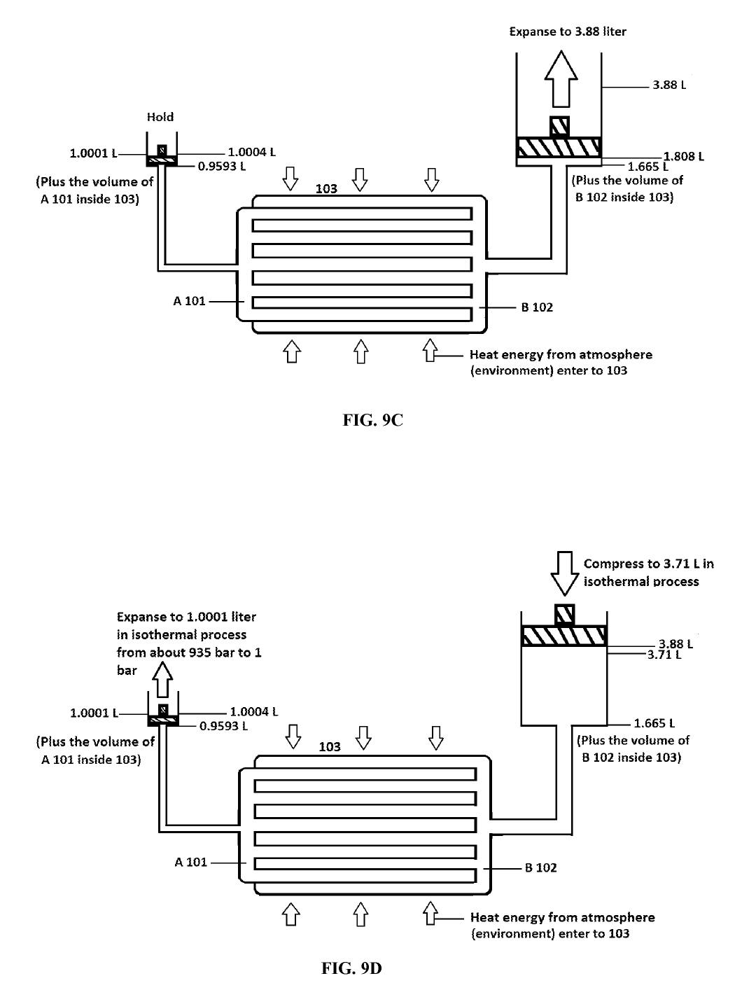

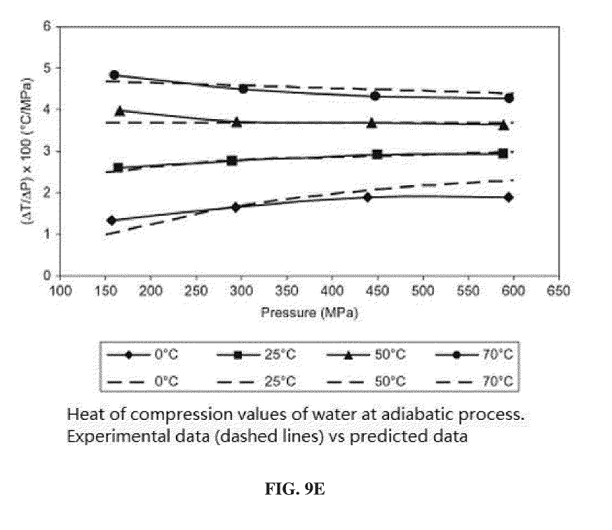

FIG. 9A is a schematic diagram depicting the functionality of cold heat engine 100 in step 1 which uses water as the substance A 101 and which uses a compressed atmosphere air as the substance B 102.

This engine 100 uses 1 kg water and 1.087 kg compressed atmosphere air to be the substance A 101 and substance B 102, 2 kg of aluminium alloy is considered to be the substance of container isolate and containing water and compressed atmosphere air at the heat exchanger 103. In this step, ±25 J heat energy from environment enters to heat exchanger 103.

In step one, compress the compressed atmosphere air from 3.71 litres to 1.665 litres to heat up 1 kg water, 2 kg aluminium alloy (container) and itself from 1° C. to 11.14° C. Water pressure is maintained at 1 bar with little thermal expansion from 1.0001 litre to ±1.0004 litre.

Plus the heat energy entered from the environment at this step and the work paid to compress compressed atmosphere air during heat up process in this step, the energy is the same with the total heat energy increased at 1 kg water, 1.087 kg compressed atmosphere air and 2 kg aluminium alloy.

$$512 \times \frac{273.14 + 1 + \frac{10.14}{2}}{273.14} \times ln ( \frac{3.71}{1.665} ) \times 9.8 \times {10}^{2} \times 0.1 \times 1.665 = 6.84 \times {10}^{4} J$$

“10²×0.1” is 100 cm² area from one surface of an 10⁻³ m³ equilateral cubic which has 0.1 m length at each side, which is an unit of volume to water and compressed atmosphere air in calculation.

“1.665” (litre) is the volume of compressed atmosphere air after compression in this step.

“512” (bar) is pressure of compressed atmosphere air at 0° C., “(273.14+1+10.14/2)/273.14” is the calculation of temperature influence the pressure, which is based on ideal gas law.

The temperature increase at 1 kg water, 1.087 kg compressed atmosphere air and 2 kg aluminium alloy is:

$$\frac{6.84 \times {10}^{4} + 25}{4205 \times 1 + 720 \times 1.087 + 880 \times 2} = 10.14 ° C .$$

“4205” J/(kg·K) is the mean specific heat at constant pressure of water from 1° C. to 11.14° C.

“720” J/(kg·K) is the mean specific heat at constant volume of 79% nitrogen (1% other gas in composition of atmosphere air is replaced by nitrogen) and 21% oxygen.

“880” (J/(kg·K) is the specific heat of aluminium alloy.

“1.087” (kg) is the weight of compressed atmosphere air, where it can calculate from 512 bar in 1.665 litres in 0° C., because in 1 bar 1000 litres atmosphere air at 0° C. have 1.275 kg weight, so

$$1.275 \times 1.6665 \times \frac{1}{1000} \times 512 = 1.087 kg .$$

“25” (J) is approximate heat energy from environment enter to heat exchanger 103.

Temperature of substance A 101 and substance B 102 increased to 284.28 K at the end of this step.

### Step Two is Working Substance B 102 (Substance B) Isothermal Expansion Process in High Temperature and High Pressure (Contrast to it Isothermal Compression Process)

FIG. 9B is a schematic diagram depicting the functionality of cold heat engine 100 in step 2 which uses water as the substance A 101 and which uses a compressed atmosphere air as the substance B 102.

In step two, water is compressed from 1 bar to 1000 bar to generate the compression heat of liquid, in the meantime, expand the volume of compressed atmosphere air from 1.665 litres to 1.808 litres to absorb all the heat energy generated by compression heat of water, in this process, temperature of 1 kg water, 1.087 kg compressed atmosphere air and 2 kg aluminium alloy (container) at heat exchanger 103 maintain ±0.1° C. range at 11.14° C.

In this step, ±25 J heat energy from environment enters to heat exchanger 103 of the engine 100.

If compress water at 11.14° C. from 1 bar to 1000 bar in adiabatic compression process, the water temperature will increase ±1.77° C., so the heat energy of it generated is about:

$$\frac{4184 + 3891}{2} \times 1.77 = 7.15 \times {10}^{3} J$$

“(4184+3891)/2” J/(kg·K) is the mean specific heat at constant volume of water at ±11.14° C. from 1 bar to 1000 bar.

The work paid to compress water from 1 bar to 1000 bar is:

$$\frac{1 + 1000}{2} \times 9.8 \times {10}^{2} \times 0.1 \times ( \frac{1}{0.9996} - \frac{1}{1.0424} ) \approx 2 \times {10}^{3} J$$

“1/0.9996” and “1/1.0424” (10⁻³ m³) is the volume of 1 kg water at 11.14° C. in 1 bar and 1000 bar.

The work obtained from expansion of compressed atmosphere air is same with the heat energy generated by compressed water from 1 bar to 1000 bar with plus the heat energy absorbed from environment in this step.

$$512 \times \frac{273.14 + 11.14}{273.14} \times ln 1.086 \times 9.8 \times {10}^{2} \times 0.1 \times 1.665 \approx ( 7.15 + 0.025 ) \times {10}^{3} J$$

“512×(273.14+11.14)/273.14” (bar) is pressure based on the principle of isochoric change of state from ideal gas law, in same volume, 512 bar is pressure at 0° C., 512×(273.14+11.14)/273.14 bar is pressure at 11.11° C.

“25” (J) is the heat energy enter to heat exchanger 103 from environment.

Volume of compressed atmosphere air increased from 1.665 litres to 1.808 litres.

1.665×1.086=1.808 litres.

### Step Three is Cooling Down Process

FIG. 9C is a schematic diagram depicting the functionality of cold heat engine 100 in step 3 which uses water as the substance A 101 and which uses a compressed atmosphere air as the substance B 102.

In this step, the compressed atmosphere air is expanded from 1.808 litres to 3.88 litres to cool down 1 kg water, 1.087 kg compressed atmosphere air and 2 kg aluminium alloy (container) at heat exchanger 103 from 11.14° C. to 1° C.

1 kg water maintained its volume in this step.

In this step, ±25 J heat energy from environment enters to the heat exchanger 103.

The work obtained from expansion of compressed atmosphere air in this step is:

$$\frac{532.88}{1.086} \times \frac{273.14 + 11.14 - \frac{10.14}{2}}{273.14 + 11.14} \times 1.808 \times ln \frac{3.88}{1.808} \times 9.8 \times {10}^{2} \times 0.1 = 6.52 \times {10}^{4} J$$

“532.88/1.086” (bar) is the pressure of compressed atmosphere air before expansion in this step.

“(273.14+11.14−10.14/2)/(273.14+11.14)” is the temperature influenced the pressure of ideal gas, it is based on the principle of isochoric change of state from ideal gas law.

“1.808” (litre) is volume of compressed atmosphere air before expansion in this step.

Heat energy stored at 1 kg water, 1.087 kg compressed atmosphere air and 2 kg aluminium alloy (container) at heat exchanger 103 in 1° C. is:

(3892×1+720×1.087+880×2)×1=6.43×10³ J

“3892” J/(kg·K) is mean specific heat at constant volume of water from ±11.14° C. at 1000 bar to 1° C. at ±935 bar.

The calculation of temperature goes down at 1 kg water, 1.087 kg compressed atmosphere air and 2 kg aluminium alloy (container) at heat exchanger 103 is:

$$\frac{6.52 \times {10}^{4} - 25}{0.643 \times {10}^{4}} = 10.14 ° C .$$

“25” (J) is heat energy from environment to heat exchanger 103.

In end of this step temperature of substance A 101 and substance B 102 change to:

11.14−10.14=1° C.

### Step Four is Working Substance B 102 (Substance B) Isothermal Compression Process in Low Temperature and Low Pressure (Contrast to it Isothermal Expansion Process)

FIG. 9D is a schematic diagram depicting the functionality of cold heat engine 100 in step 4 which uses water as the substance A 101 and which uses a compressed atmosphere air as the substance B 102.

In step four, expand water from ±935 bar at 0.9593 litre to 1 bar at 1.0001 litre to absorb the heat energy generate by compress the compressed atmosphere air from 3.88 litres to 3.71 litres.

In this step, ±25 J heat energy from environment enters to heat exchanger 103.

The heat energy absorbed by water expansion from ±935 bar to 1 bar at ±1° C. is:

$$\frac{3894 + 4213}{2} \times 1 \times \frac{935}{1000} \approx 3.79 \times {10}^{3} J$$

“(3894+4213)/2” J/(kg·K) is the mean specific heat at constant volume of water at ±11.14° C. from ±935 bar to 1 bar.

“1” (° C.) is the temperature of water increase in adiabatic compression process at ±1° C. from 1 bar to 1000 bar. In water adiabatic expansion process from 1000 bar to 1 bar at ±1° C., the temperature of water decreases by ±1° C.

The heat energy can be generated by compression of compressed atmosphere air which is same with the work paid in compression of compressed atmosphere air in this step.

$$512 \times \frac{1.665}{3.71} \times \frac{273.14 + 1}{273.14} \times 3.71 \times ln 1.0458 \times 9.8 \times {10}^{2} \times 0.1 \approx 3.76 \times {10}^{3} J$$

“512×1.665/3.71×(273.14+1)/273.14” (bar) is the pressure of compressed atmosphere air after compression in this step.

The heat energy generated by compression of compressed atmosphere air plus the heat energy from environment enters to the heat exchanger 103 in this step:

(3.76+0.025)×10³≈3.79×10³ J

The water pressure change from 1000 bar to ±935 bar is because temperature of water decreased ±10° C., in same pressure its volume at 1° C. smaller than the volume at 11.14° C.

“1042.4” (kg/m̂3) is the density of water in 935 bar at 1° C. which have same density with water in 1000 bar at +11.14° C.

“1042.4” (kg/m̂3) is the density of water in 1000 bar at 11.14° C.

The work obtained from water expansion in this step is:

$$\frac{935 + 1}{2} \times 9.8 \times {10}^{2} \times 0.1 \times ( \frac{1}{0.9999} - \frac{1}{1.0424} ) \approx 1.87 \times {10}^{3} J$$

“1/1.0424” (litre) is volume of 1 kg water at 1° C. in ±935 bar.

“1/0.9999” (litre) is volume of 1 kg water at 1° C. in 1 bar.

After step four, this engine 100 (method) will go to step one again.

Sum of all the Work Paid and Obtained from Step One to Step Four:

<(−6.84)+(−0.2+0.72)+(6.52)+(0.19−0.38)>×10⁴≈1×10²¹ J

So the cold heat engine 100 uses water and compressed atmosphere air to be the substance A 101 and substance B 102 which can produce ±1×10² J mechanical energy when it completed one cycle of the process.

The mechanical energy of this engine 100 is generated and is fixed with the heat energy absorbed by this engine 100.

25+25+25+25=±1×10² J

FIG. 9E is the diagram show the compression heat of water. This diagram is obtained from “Novel Thermal and Non-thermal Technologies for Fluid Foods” edited by P. J. Cullen, Brijesh K. Tiwari, Vasilis P. Valdramidis.

As will be understood by those familiar with the art, the invention may be embodied in other specific forms without departing from the essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three.

Accordingly, the disclosure of the present invention is intended to be illustrative, but not limiting, of the scope of the invention, which is set forth in the following claims.

1. A cold heat engine designed to provide high efficiency mechanical energy output and to eliminate consumption of fuel by converting heat energy absorbed from environment to mechanical energy, said cold heat engine comprising:
a first substance to produce compression heat, heat absorption of expansion and let latent heat occurs when said first substance changes phase, wherein said first substance releases and absorbs heat energy;
a second substance to produce compression heat, heat absorption of expansion and let latent heat occurs when said second substance changes phase, wherein said second substance releases and absorbs heat energy;
wherein said second substance expands in a high temperature and compresses in a low temperature to earn a substantial amount of mechanical energy, and wherein said second substance absorbs heat energy from said first substance and let said first substance to absorb heat energy from said second substance;
a container containing said first substance and said second substance, wherein said container is built by high heat conductivity material of at least one of aluminium alloy, steel, carbon fibre or any other suitable material; and
a heat exchanger designed to allow said first substance and said second substance to exchange said heat energy, wherein the heat energy can also be absorbed from the environment by the surface at a side section
wherein said first substance and said second substance are substances which cooperate together to absorb heat energy from the environment and convert the heat energy to said mechanical energy.

2. The cold heat engine as claimed in claim 1, wherein said first substance provides heat energy to said second substance, when said second substance expands in volume at high temperatures.

3. The cold heat engine as claimed in claim 1, wherein said first substance absorbs heat energy from said second substance, when said second substance compresses in volume at low temperatures.

4. The cold heat engine of claim 1, wherein the cold heat engine earns mechanical energy by expansion of said second substance in high temperatures and compression of said second substance in low temperatures.

5. The cold heat engine of claim 1, wherein the cold heat engine is adapted to absorb heat energy from the environment when the cold heat engine outputs a substantial amount of said mechanical energy.

6. The cold heat engine as claimed in claim 1, wherein during phase changing, latent heat is a source which provides and absorbs the heat energy and further wherein during a single phase in process for said first substance and said second substance, the latent heat is not transmitted.

7. The cold heat engine as claimed in claim 1, wherein the heat exchanger is built by high heat conductivity and at least of one of the substances of aluminium alloy, steel, carbon fibre or any other suitable material.

8. The cold heat engine as claimed in claim 1, wherein the heat exchanger allows said first substance and said second substance to exchange and absorb the heat energy.

9. The cold heat engine as claimed in claim 1, wherein said first substance and said second substance freezing on the inner surface of the container freezes in a bulk form at a surface of the container where it changes phase from liquid to solid to release the latent heat.

10. The cold heat engine as claimed in claim 1, wherein the cold heat engine comprises at least one of propeller, diaphragm, piston or any other device to let substance absorb the heat energy from the environment and to flow inside the heat exchanger.

11. The cold heat engine as claimed in claim 1, wherein the cold heat engine comprises a high heat conductivity plate to absorb the heat energy from environment and conduct to inside the heat exchanger.
